(19) United States
(12) Patent Application Publication
(10) Pub. No.: US 2026/0267974 A1
(43) Pub. Date: Sep. 10, 2026

(54) SYSTEMS AND METHODS FOR FACILITATING REMEDIAL ACTIONS TO CYBERSECURITY VULNERABILITIES

(71) Applicant: Guardare, Inc., Clearwater, FL (US)

(72) Inventors: Thomas Dane Fiori, JR., Clearwater, FL (US); Charles Warren Mitchell, Clearwater, FL (US)

(73) Assignee: Guardare, Inc., Clearwater, FL (US)

(21) Appl. No.: 19/560,362

(22) Filed: Mar. 9, 2026

Related U.S. Application Data
(60) Provisional application No. 63/769,344, filed on Mar. 10, 2025.

(51) Int. Cl. G06F 21/55

(52) U.S. Cl. CPC G06F 21/554; G06F 2221/034

(57) ABSTRACT

Methods and systems are described herein for facilitating remedial actions to cybersecurity vulnerabilities. The system can identify electronic documents corresponding to different network security frameworks providing structured approaches for managing cybersecurity risk. The system can generate a vector database comprising embeddings converted from the electronic documents. The system can generate a graph data structure comprising nodes corresponding to controls or requirements of the security frameworks and nodes representing objects of a computing environment. The system can generate an embedding of an input, identify embeddings from the vector database based on the input embedding, and query the graph data structure to identify a subset of nodes. The system can generate a subgraph and generate a remedial action for addressing a gap in a control or requirement of an applicable security framework.

### CROSS-REFERENCE TO RELATED APPLICATIONS

This application claims the benefit of priority to U.S. Provisional Application No. 63/769,344, filed Mar. 10, 2025, the entirety of which is incorporated by reference herein.

### BACKGROUND

Retrieval-Augmented Generation (RAG) models can retrieve relevant context (e.g., document chunks) from a vector database using similarity search techniques between embeddings of a request and embeddings of chunked documents stored in the vector database to generate a relevant response to the request. However, similarity search techniques are limited when attempting to retrieve relevant context that may be conceptually identical but represented in a different syntax, as embeddings and embedding similarity search techniques rely on the syntax of chunked documents. As a result, relevant context may not be retrieved for use in response generation despite the context being associated with conceptually similar or identical information as the request.

### SUMMARY

This disclosure relates to techniques for generating remedial actions to address cybersecurity vulnerabilities by combining vector database similarity search with graph data structure querying to provide context-aware security recommendations based on multiple network security frameworks. Retrieval-Augmented Generation (RAG) systems can retrieve relevant context from a vector database using similarity search techniques between embeddings of a request and embeddings of chunked documents stored in the vector database. However, vector database similarity search techniques are limited when attempting to retrieve relevant context that may be conceptually identical but represented in different syntax, as embeddings and embedding similarity search techniques rely on the syntax of chunked documents. This technical limitation is particularly relevant with respect to network security framework information that use particular lexicons when describing controls or requirements to ensure secure computer networks. As a result, when recommendations are generated, mitigation strategies for another platform may be missed because, while conceptually similar, the vector database search relies solely on syntactic similarity and the query being provided. Although graph data structures can preserve relationship information between data elements, graph data structures require specific queries to retrieve information as opposed to simple similarity or semantic search. As such, graph data structures lack the flexibility to handle queries (e.g., requests, user requests, etc.) that do not exactly match stored relationship structures for traversing and retrieving information from graph data structure, resulting in incomplete security assessments and may miss critical compliance gaps when generating remedial actions.

The techniques described herein provide approaches for combining vector database similarity search with graph data structure querying to generate targeted remedial actions for cybersecurity vulnerabilities. To do so, the techniques described herein can leverage a combination of a vector database and a graph data structure, where the vector database similarity search can identify nodes corresponding to relevant security framework controls or requirements of a request, and the graph data structure can be used to generate a targeted subgraph using the identified nodes to extract preserved relationships between syntactically dissimilar and syntactically similar elements of security frameworks and computing objects. The techniques described herein can use a graph neural network to process the subgraph to further identify patterns and infer connections between nodes that may not be preserved in the subgraph, including connections between conceptually similar controls that are syntactically different across different security frameworks, and gaps in controls or requirements of security frameworks respective to computing objects of a computing environment. In doing so, the techniques described herein can generate computing environment-specific recommendations (e.g., remedial actions) based on preserved, learned relationships that account for conceptual similarity rather than relying solely on syntactic similarity. The techniques described herein can further automatically implement generated recommendations within the computing environment, thereby improving the computer environment's cybersecurity posture prior to a cybersecurity attack.

At least one aspect relates to a system. The system can include memory and one or more processors configured by machine-readable instructions stored in the memory to perform one or more operations. The system can identify one or more electronic documents each corresponding to a different network security framework providing a structured approach for managing and reducing cybersecurity risk. The system can generate a vector database comprising embeddings converted from each of the one or more electronic documents. The system can generate a graph data structure comprising a first set of nodes corresponding to controls or requirements of the different network security frameworks. Each of the first set of nodes stores an embedding from the vector database corresponding to a control or requirement represented by the node. The graph data structure further comprises a second set of nodes representing objects of a computing environment. The system can generate an embedding of an input requesting information about the different network security frameworks as related to the objects of the computing environment. The system can identify one or more embeddings of portions of electronic documents corresponding to network security frameworks applicable to the computing environment from the vector database based on the embedding of the input. The system can query the graph data structure using the one or more embeddings to identify a subset of the first set of nodes that correspond to controls or requirements of the network security frameworks applicable to the computing environment. The system can generate a subgraph from the identified subset of the first set of nodes that correspond to the controls or requirements of the security frameworks applicable to the computing environment and a subset of the second set of nodes linked by edges with the first set of nodes representing objects of the computing environment. The system can generate, using the edges between the first and second sets of nodes of the subgraph, a remedial action for addressing a gap in a control or requirement of an applicable security framework with respect to one or more objects of the computing environment.

In some implementations, the system can receive the input as a natural language query from a user interface presented on a client device. In some implementations, the system can present an indication of the remedial action at the client device on the user interface.

In some implementations, the system can automatically implement the remedial action within the computing environment to reduce cybersecurity risk within the computing environment.

In some implementations, the system can automatically implement the remedial action by automatically initiating at least one configuration change, security control adjustment, or software update to a component of the computing environment.

In some implementations, the system can generate the remedial action for addressing the gap in the control or requirement of the applicable security framework with respect to one or more objects of the computing environment by generating an indication of an expected-but-missing edge between nodes of the subgraph, an indication of an expected-but-missing node within the subgraph, or an indication of an unexpected node or edge within the subgraph.

In some implementations, the system can retrieve the portions of the electronic documents corresponding to the one or more embeddings based on the embedding of the input. In some implementations, the system can generate the remedial action based further on the retrieved portions of the electronic documents.

In some implementations, the system can generate the remedial action by executing a graph neural network using the subgraph as input. In some implementations, the graph neural network is trained based on one or more historical subgraphs containing nodes generated based on the different network security frameworks.

In some implementations, the system can generate the remedial action by executing a large language model using an output of the graph neural network generated based on the input to generate the remedial action.

In some implementations, the system can execute the large language model to generate the remedial action by iteratively repeating the query of the graph data structure, the generation of the subgraph, the execution of the large language model, and the execution of the graph neural network until determining the remedial action satisfies an acceptance criteria.

In some implementations, the system can execute the large language model to generate the remedial action by executing, as part of determining whether the remedial action satisfies the acceptance criteria, a validation large language model configured to evaluate completeness of the remedial action relative to the subgraph to determine whether the remedial action satisfies the acceptance criteria. In some implementations the system can execute the large language model to generate the remedial action by, responsive to the validation large language model determining that the remedial action is incomplete based on the determination as to whether the remedial action satisfies the acceptance criteria, automatically trigger at least one additional iteration of the query of the graph data structure and the generation of the subgraph to obtain additional controls, requirements, or objects omitted from a prior iteration.

In some implementations, the system can generate the remedial action by executing a graph neural network using the subgraph as input to generate a plurality of candidate remedial actions and confidence scores for the plurality of candidate remedial actions. In some implementations, the system can generate the remedial action by executing a large language model using the plurality of candidate remedial actions and the confidence scores for the plurality of candidate remedial actions to select the remedial action.

At least one other aspect relates to a method. The method can be performed, for example, by one or more processors coupled to non-transitory memory. The method can include identifying one or more electronic documents each corresponding to a different network security framework providing a structured approach for managing and reducing cybersecurity risk. The method can include generating a vector database comprising embeddings converted from each of the one or more electronic documents. The method can include generating a graph data structure comprising a first set of nodes corresponding to controls or requirements of the different network security frameworks. Each of the first set of nodes stores an embedding from the vector database corresponding to a control or requirement represented by the node. The graph data structure further comprises a second set of nodes representing objects of a computing environment. The method can include generating an embedding of an input requesting information about the different network security frameworks as related to the objects of the computing environment. The method can include identifying one or more embeddings of portions of electronic documents corresponding to network security frameworks applicable to the computing environment from the vector database based on the embedding of the input. The method can include querying the graph data structure using the one or more embeddings to identify a subset of the first set of nodes that correspond to controls or requirements of the network security frameworks applicable to the computing environment. The method can include generating a subgraph from the identified subset of the first set of nodes that correspond to the controls or requirements of the security frameworks applicable to the computing environment and a subset of the second set of nodes linked by edges with the first set of nodes representing objects of the computing environment. The method can include generating, using the edges between the first and second sets of nodes of the subgraph, a remedial action for addressing a gap in a control or requirement of an applicable security framework with respect to one or more objects of the computing environment.

In some implementations, the method can include receiving the input as a natural language query from a user interface presented on a client device. In some implementations, the method can include presenting an indication of the remedial action at the client device on the user interface.

In some implementations, the method can include automatically implementing the remedial action within the computing environment to reduce cybersecurity risk within the computing environment.

In some implementations, the method can include automatically implementing the remedial action by automatically initiating at least one configuration change, security control adjustment, or software update to a component of the computing environment.

In some implementations, the method can include generating the remedial action for addressing the gap in the control or requirement of the applicable security framework with respect to one or more objects of the computing environment by generating an indication of an expected-but-missing edge between nodes of the subgraph, an indication of an expected-but-missing node within the subgraph, or an indication of an unexpected node or edge within the subgraph.

In some implementations, the method can include retrieving the portions of the electronic documents corresponding to the one or more embeddings based on the embedding of the input. In some implementations, the method can include generating the remedial action based further on the retrieved portions of the electronic documents.

In some implementations, the method can include generating the remedial action by executing a graph neural network using the subgraph as input. In some implementations, the graph neural network is trained based on one or more historical subgraphs containing nodes generated based on the different network security frameworks.

In some implementations, the method can include generating the remedial action by executing a large language model using an output of the graph neural network generated based on the input to generate the remedial action.

In some implementations, the method can include executing the large language model to generate the remedial action by iteratively repeating the query of the graph data structure, the generation of the subgraph, the execution of the large language model, and the execution of the graph neural network until determining the remedial action satisfies an acceptance criteria.

In some implementations, the method can include executing the large language model to generate the remedial action by executing, as part of determining whether the remedial action satisfies the acceptance criteria, a validation large language model configured to evaluate completeness of the remedial action relative to the subgraph to determine whether the remedial action satisfies the acceptance criteria. In some implementations the method can include executing the large language model to generate the remedial action by, responsive to the validation large language model determining that the remedial action is incomplete based on the determination as to whether the remedial action satisfies the acceptance criteria, automatically triggering at least one additional iteration of the query of the graph data structure and the generation of the subgraph to obtain additional controls, requirements, or objects omitted from a prior iteration.

In some implementations, the method can include generating the remedial action by executing a graph neural network using the subgraph as input to generate a plurality of candidate remedial actions and confidence scores for the plurality of candidate remedial actions. In some implementations, the method can include generating the remedial action by executing a large language model using the plurality of candidate remedial actions and the confidence scores for the plurality of candidate remedial actions to select the remedial action.

At least one other aspect relates to one or more non-transitory computer-readable media. The non-transitory computer-readable media can store instructions that, when executed by one or more processors, cause the one or more processors to perform operations. The operations can include identifying one or more electronic documents each corresponding to a different network security framework providing a structured approach for managing and reducing cybersecurity risk. The operations can include generating a vector database comprising embeddings converted from each of the one or more electronic documents. The operations can include generating a graph data structure comprising a first set of nodes corresponding to controls or requirements of the different network security frameworks. Each of the first set of nodes stores an embedding from the vector database corresponding to a control or requirement represented by the node. The graph data structure further comprises a second set of nodes representing objects of a computing environment. The operations can include generating an embedding of an input requesting information about the different network security frameworks as related to the objects of the computing environment. The operations can include identifying one or more embeddings of portions of electronic documents corresponding to network security frameworks applicable to the computing environment from the vector database based on the embedding of the input. The operations can include querying the graph data structure using the one or more embeddings to identify a subset of the first set of nodes that correspond to controls or requirements of the network security frameworks applicable to the computing environment. The operations can include generating a subgraph from the identified subset of the first set of nodes that correspond to the controls or requirements of the security frameworks applicable to the computing environment and a subset of the second set of nodes linked by edges with the first set of nodes representing objects of the computing environment. The operations can include generating, using the edges between the first and second sets of nodes of the subgraph, a remedial action for addressing a gap in a control or requirement of an applicable security framework with respect to one or more objects of the computing environment.

In some implementations, the operations can include receiving the input as a natural language query from a user interface presented on a client device. In some implementations, the operations can include presenting an indication of the remedial action at the client device on the user interface.

In some implementations, the operations can include automatically implementing the remedial action within the computing environment to reduce cybersecurity risk within the computing environment.

In some implementations, the operations can include automatically implementing the remedial action by automatically initiating at least one configuration change, security control adjustment, or software update to a component of the computing environment.

In some implementations, the operations can include generating the remedial action for addressing the gap in the control or requirement of the applicable security framework with respect to one or more objects of the computing environment by generating an indication of an expected-but-missing edge between nodes of the subgraph, an indication of an expected-but-missing node within the subgraph, or an indication of an unexpected node or edge within the subgraph.

In some implementations, the operations can include retrieving the portions of the electronic documents corresponding to the one or more embeddings based on the embedding of the input. In some implementations, the operations can include generating the remedial action based further on the retrieved portions of the electronic documents.

In some implementations, the operations can include generating the remedial action by executing a graph neural network using the subgraph as input. In some implementations, the graph neural network is trained based on one or more historical subgraphs containing nodes generated based on the different network security frameworks.

In some implementations, the operations can include generating the remedial action by executing a large language model using an output of the graph neural network generated based on the input to generate the remedial action.

In some implementations, the operations can include executing the large language model to generate the remedial action by iteratively repeating the query of the graph data structure, the generation of the subgraph, the execution of the large language model, and the execution of the graph neural network until determining the remedial action satisfies an acceptance criteria.

In some implementations, the operations can include executing the large language model to generate the remedial action by executing, as part of determining whether the remedial action satisfies the acceptance criteria, a validation large language model configured to evaluate completeness of the remedial action relative to the subgraph to determine whether the remedial action satisfies the acceptance criteria. In some implementations the operations can include executing the large language model to generate the remedial action by, responsive to the validation large language model determining that the remedial action is incomplete based on the determination as to whether the remedial action satisfies the acceptance criteria, automatically triggering at least one additional iteration of the query of the graph data structure and the generation of the subgraph to obtain additional controls, requirements, or objects omitted from a prior iteration.

In some implementations, the operations can include generating the remedial action by executing a graph neural network using the subgraph as input to generate a plurality of candidate remedial actions and confidence scores for the plurality of candidate remedial actions. In some implementations, the operations can include generating the remedial action by executing a large language model using the plurality of candidate remedial actions and the confidence scores for the plurality of candidate remedial actions to select the remedial action.

### BRIEF DESCRIPTION OF THE DRAWINGS

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles, and concepts. The drawings are not intended to limit the scope of the claims included herewith.

FIG. 1A illustrates an example block diagram depicting a computing device, in accordance with one or more embodiments.

FIG. 1B illustrates an example block diagram depicting a computing environment comprising a client device in communication with cloud service providers, in accordance with one or more embodiments.

FIG. 2A illustrates an example block diagram depicting a system using supervised learning, in accordance with one or more embodiments.

FIG. 2B illustrates an example block diagram depicting a simplified neural network model, in accordance with one or more embodiments.

FIG. 3A is an illustration of an example system for facilitating remedial actions to cybersecurity vulnerabilities, in accordance with an implementation.

FIG. 3B illustrates an example graph data structure, in accordance with an implementation.

FIG. 3C illustrates an example subgraph data structure of the example graph data structure of FIG. 3B, in accordance with an implementation.

FIG. 4A is an illustration of an example subsystem to generate remedial actions for cybersecurity vulnerabilities, in accordance with an implementation.

FIG. 4B illustrates an example flowchart of a process for facilitating remedial actions to cybersecurity vulnerabilities, in accordance with an implementation.

### DETAILED DESCRIPTION

For purposes of reading the description of the various embodiments below, the following descriptions of the sections of the specification and their respective contents can be helpful:
Section A describes a computing environment and network environment that can be useful for practicing embodiments described herein.
Section B describes an artificial intelligence environment that can be useful for practicing embodiments described herein.
Section C describes a computing system and graph data structures used for generating remedial actions for cyber security vulnerabilities, in accordance with embodiments described herein.
Section D describes systems and methods for facilitating remedial actions to cybersecurity vulnerabilities, in accordance with embodiments described herein.

### A. Computing and Network Environment

Prior to discussing the specifics of embodiments of facilitating remedial actions to cybersecurity vulnerabilities, it may be helpful to discuss the computing environments in which such embodiments may be deployed.

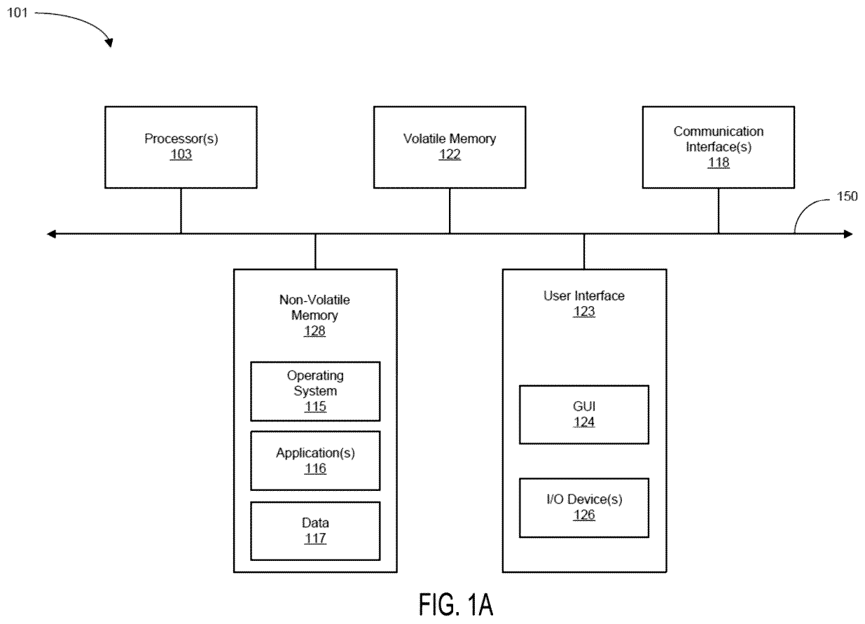

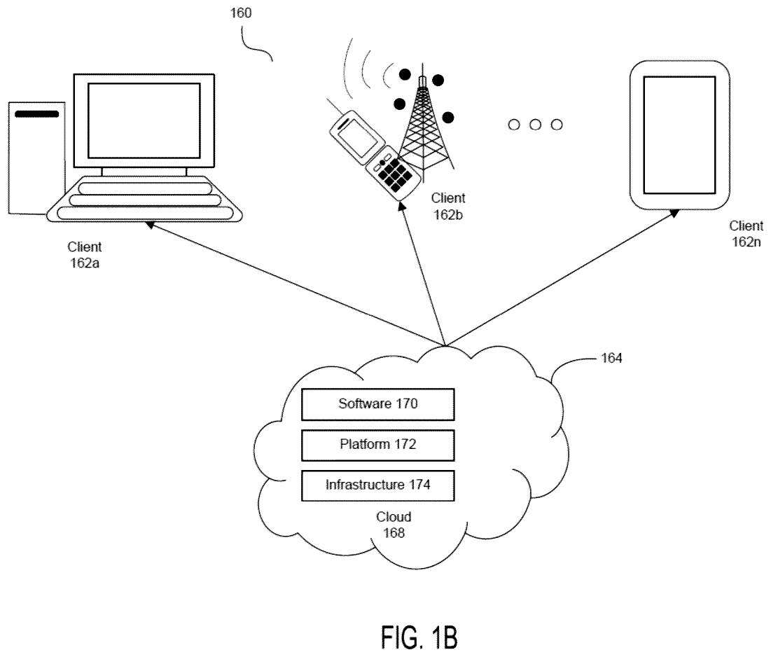

As shown in FIG. 1A, computer 101 may include one or more processors 103, volatile memory 122 (e.g., random access memory (RAM)), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, one or more accelerometers, etc.). Non-volatile memory 128 stores operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computer 101 may communicate via one or more communication buses, shown as communication bus 150.

Computer 101 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 118 may include one or more interfaces to enable computer 101 to access a computer network such as a Local Area Network (LAN), a Wide Area Network (WAN), a Personal Area Network (PAN), or the Internet through a variety of wired and/or wireless or cellular connections.

In described embodiments, the computing device 101 may execute an application on behalf of a user of a client computing device. For example, the computing device 101 may execute a virtual machine, which provides an execution session within which applications execute on behalf of a user or a client computing device, such as a hosted desktop session. The computing device 101 may also execute a terminal services session to provide a hosted desktop environment. The computing device 101 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers, processing, memory, storage, applications, virtual machines, databases, software, hardware, analytics, and intelligence.

In embodiments, the computing environment 160 may provide client 162 with one or more resources provided by a network environment. The computing environment 160 may include one or more clients 162a-162n, in communication with a cloud 168 over one or more networks 164. Clients 162 may include, e.g., thick clients, thin clients, and zero clients. The cloud 108 may include back end platforms, e.g., servers 106, storage, server farms or data centers. The clients 162 can be the same as or substantially similar to computer 101 of FIG. 1A.

The users or clients 162 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 108 may be public, private, or hybrid. Public clouds 108 may include public servers that are maintained by third parties to the clients 162 or the owners of the clients 162. The servers may be located off-site in remote geographical locations as disclosed above or otherwise. Public clouds 168 may be connected to the servers over a public network 164. Private clouds 168 may include private servers that are physically maintained by clients 162 or owners of clients 162. Private clouds 168 may be connected to the servers over a private network 164. Hybrid clouds 168 may include both the private and public networks 164 and servers.

The cloud 168 may include back end platforms, e.g., servers, storage, server farms or data centers. For example, the cloud 168 can include or correspond to a server or system remote from one or more clients 162 to provide third party control over a pool of shared services and resources. The computing environment 160 can provide resource pooling to serve multiple users via clients 162 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 162. The computing environment 160 can provide an elasticity to dynamically scale out or scale in responsive to different demands from one or more clients 162. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include serverless computing. The computing environment 160 can include Software as a service (SaaS). For example, the cloud 168 may also include a cloud based delivery, e.g., Software as a Service (SaaS) 170, Platform as a Service (PaaS) 172, and Infrastructure as a Service (IaaS) 174. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon. com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce. com Inc. of San Francisco, California, or OFFICE 365 provided by Microsoft Corporation. Examples of SaaS may also include data storage providers, e.g., DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 162 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 162 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 162 may access SaaS resources through the use of web-based user interfaces, provided by a web browser (e.g., GOOGLE CHROME, Microsoft INTERNET EXPLORER, or Mozilla Firefox provided by Mozilla Foundation of Mountain View, California). Clients 162 may also access SaaS resources through smartphone or tablet applications, including, e.g., Salesforce Sales Cloud, or Google Drive app. Clients 162 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Artificial Intelligence Environment

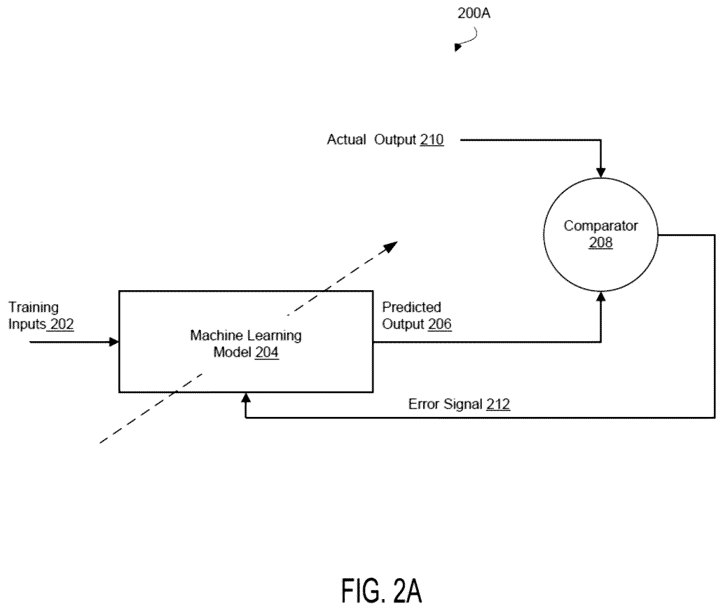

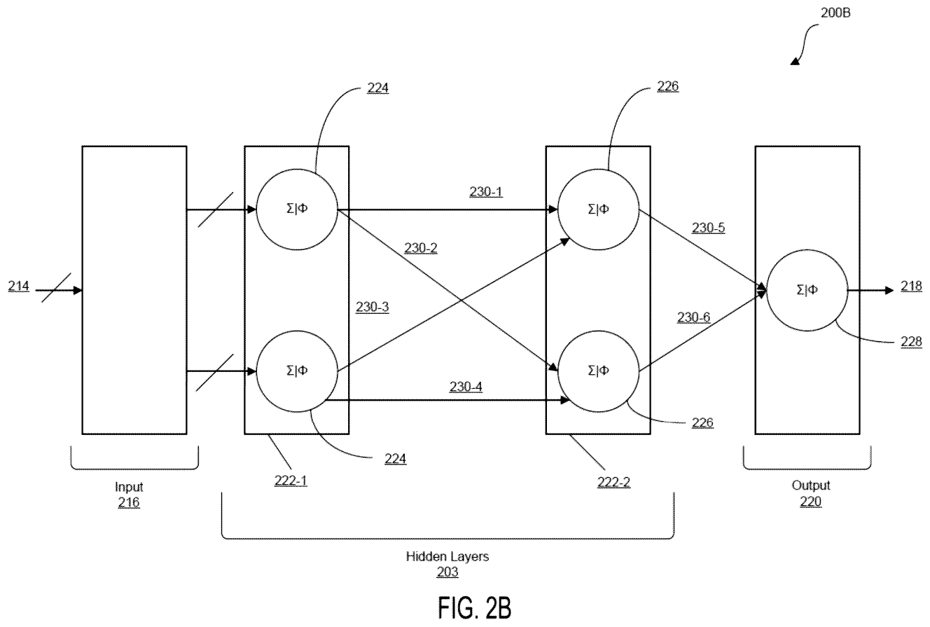

Referring to FIG. 2A, an embodiment of an artificial intelligence environment 200A is depicted. The artificial intelligence environment 200A may incorporate various machine learning models to process data, identify patterns, and generate predictions or decisions. By way of example, machine learning models can comprise supervised learning models, clustering models, neural network models, deep learning models, reinforcement learning models, unsupervised models, decision trees, support-vector machines, Bayesian networks, Gaussian processes, genetic algorithms models, generative models, image and text processing models, video processing models, any other models that can be used by one or more machine learning algorithms, any other models that can learn from data (e.g., training data) to perform tasks without explicit instructions, or various combinations thereof. They can also involve combinations of the above and agentic systems that leverage models and underlying data. The neural network models can comprise, for example and without limitation, artificial neural networks (ANNs), deep neural networks (DNNs), deep belief networks (DBNs), one or more language models, large language models (LLMs), attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs), graph neural networks (GNNs), any other models that can learn patterns and make predictions or decisions, or various combinations thereof.

The machine learning models can be configured, learned, or trained using various learning or training operations, such as unsupervised learning, weakly supervised learning, semi-supervised learning, supervised learning, or any other learning or training operations that can learn from data (e.g., training data) and generalize to unseen data, or various combinations thereof. For example, parameters of nodes of a neural network model, such as weights, biases, and/or thresholds, can be configured, learned, or trained using various learning or training operations, such as unsupervised learning, weakly supervised learning, semi-supervised learning, or supervised learning. A machine learning model can be configured using training data from various domain-agnostic and/or domain-specific data sources. The training data can include a plurality of training data elements (e.g., training data instances). Each training data element can be arranged in structured or unstructured formats; for example, the training data element can include an example output mapped to an example input. The training data can include data that is not separated into input and output subsets (e.g., for configuring the machine learning model to perform clustering, classification, or other unsupervised machine learning operations).

The training data can include data describing network security frameworks, controls or requirements of network security frameworks, computing environment objects (e.g., firewalls, routers, servers, load balancers, etc.), graphical data (e.g., graph data structures, etc.), network security threats, network security vulnerabilities, networking tactics, configuration profiles of computing environment objects, remedial actions, confidence scores of remedial actions, relationships between controls or requirements of network security frameworks and computing environment objects, or other information. The training data can include human-labeled information, including but not limited to feedback regarding outputs of the machine learning model, which can allow the machine learning model to generate more human-like outputs.

Referring back to FIG. 2A, a block diagram of an example system using supervised learning is shown. Supervised learning is a method of training a machine learning model given input-output pairs. An input-output pair is an input with an associated known output (e.g., an expected output).

Machine learning model 204 be trained on known input-output pairs such that the machine learning model 204 can learn how to predict known outputs given known inputs. Once the machine learning model 204 has learned how to predict known input-output pairs, the machine learning model 204 can operate on unknown inputs to predict an output. The machine learning model 204 may correspond to various models described herein, including language models (e.g., large language models), graph neural networks, validation models, or other models configured to process security-related data and generate outputs for facilitating remedial actions to cybersecurity vulnerabilities.

The machine learning model 204 may be trained based on general data and/or granular data (e.g., data based on a specific computing environment, data based on a specific network security framework, etc.) such that the machine learning model 204 may be trained specific to a particular organization's security posture. Different models may be trained using different types of data depending on their respective functions within the system.

Training inputs 202 and actual outputs 210 may be provided to the machine learning model 204. Training inputs 202 may include various types of security-related data depending on the type of model being trained. For example, training inputs 202 may include framework documentation, control specifications, compliance mappings, threat intelligence data, vulnerability assessments, annotated security scenarios, graph data structures, subgraphs, historical subgraphs, relationships between nodes, computing environment object information, remedial actions, confidence scores associated with remedial actions, graph neural network outputs, or other applicable information. The training inputs 202 may include labels indicating function categories, control family designations, framework identifiers, cross-framework mappings, question-answer pairs, or other contextual signals to provide the machine learning model 204 with relevant information during training.

The training inputs 202 and actual outputs 210 may be received from various data repositories, including the vector database 342, the graph database 344, or the system data 350. For example, a data repository may contain labeled datasets including network security framework information, graph data structures, subgraphs, relationships, missing but expected relationships, remedial actions, confidence scores of remedial actions, computing environment objects and characteristics thereof, or other information. Thus, the machine learning model 204 may be trained to predict outcomes based on the training inputs 202 and actual outputs 210 used to train the machine learning model 204. By using various labels and contextual information in conjunction with the training data, the system may provide further contextual information to the machine learning model 204 during the training routine, such that the machine learning model 204 learns to recognize patterns, relationships, and correlations relevant to its designated function.

The actual outputs 210 may be determined based on the type of model being trained and its intended function. For example, actual outputs 210 may include historic data of subgraphs related to different network security frameworks, remedial actions derived from subgraphs, graph neural network output information, confidence scores, indications of relationships or missing but expected relationships, validation determinations, or other information. In some embodiments, actual outputs 210 may be ground-truth information for training. In some embodiments, the machine learning model 204 may be continuously trained to improve its quality and accuracy in performing its designated function. The machine learning model 204 can take into account various inputs and execute operations to generate predicted outputs 206 (e.g., remedial actions, recommendations, relationships, insights, or other outputs). The actual outputs 210 may then be determined by measuring real-world outcomes, expert feedback, or other validation mechanisms. Metrics such as accuracy, completeness, consistency, and relevance may be considered when evaluating the quality of candidate outputs.

During training, the error (represented by error signal 212) determined by the comparator 208 may be used to adjust the weights in the machine learning model 204 such that the machine learning model 204 changes (or learns) over time. The machine learning model 204 may be trained using a backpropagation algorithm, for instance. The backpropagation algorithm operates by propagating the error signal 212. The error signal 212 may be calculated each iteration (e.g., each pair of training inputs 202 and associated actual outputs 210), batch and/or epoch, and propagated through the algorithmic weights in the machine learning model 204 such that the algorithmic weights adapt based on the amount of error. The error is minimized using a loss function. Non-limiting examples of loss functions may include the square error function, the root mean square error function, and/or the cross entropy error function.

The weighting coefficients of the machine learning model 204 may be tuned to reduce the amount of error, thereby minimizing the differences between (or otherwise converging) the predicted output 206 and the actual output 210. The machine learning model 204 may be trained until the error determined at the comparator 208 is within a certain threshold (or a threshold number of batches, epochs, or iterations have been reached). The trained machine learning model 204 and associated weighting coefficients may subsequently be stored in memory 312 or other data repository (e.g., a database) such that the machine learning model 204 may be employed on unknown data (e.g., not training inputs 202). Once trained and validated, the machine learning model 204 may be employed during a testing (or an inference) phase. During testing, the machine learning model 204 may ingest unknown data to predict future data (e.g., remedial actions, confidence scores, relationships, validation determinations, or other outputs relevant to facilitating remedial actions to cybersecurity vulnerabilities).

In some embodiments, the example system may include one or more machine learning models 204. For example, a first machine learning model 204 may be a large language model trained to generate remedial actions for cybersecurity vulnerabilities based on network security framework information, computing object information, or other information. In some embodiments, the first machine learning model 204 may be a RAG model that is communicatively coupled with one or more databases (e.g., vector database 342, graph database 344, etc.) or one or more retrievers (e.g., retriever 320, graph data retriever 330, etc.) to retrieve information from the one or more databases as context when generating an output (e.g., a remedial action, a recommendation, a response, etc.).

In some embodiments, the first machine learning model 204 may be trained during a first training routine. The first machine learning model 204 may be trained on a set of first training data (e.g., first training inputs 202, first actual outputs 210, etc.). The set of first training data may include first training inputs 202 that indicate network security framework information. The network security framework information may include electronic documents (or chunks thereof) corresponding to different network security frameworks such as NIST, MITRE, NIST CSF, SP 800-53, MITRE ATT&CK, CIS benchmarks, HIPAA, GDPR, SOC 2, or other security framework documents. The network security framework information may include a control identifier, a requirement specification, a function category, a risk assessment, a family classification, or other information associated with the security frameworks. The first training inputs 202 may also include computing object information corresponding to objects within a computing environment. The computing object information may include a type classification indicating a category of the computing object (e.g., firewall, router, server, load balancer), an object identifier (e.g., a particular type, manufacture, or other granular information of the computing object being considered), a state indicating a current configuration or operational status of the computing object, a platform association indicating the computing platform on which the object operates, log information capturing activity or events associated with the computing object, or other information. The first training inputs 202 may further include questions of Q&A pairs to map particular controls to plain-language explanations, scenarios classified by control families or function categories, and graph neural network output data including confidence scores of remedial actions, remedial actions, relationships between nodes, and indications of missing but expected relationships, or other information.

The set of first training data may also include first actual outputs 210 that indicate target remedial actions or recommendations to be generated based on the first training inputs 202. Such first actual outputs 210 may serve as ground truth information for training the first machine learning model 204 and may be labeled with (i) a remedial action identifier (e.g., harden a server, enable multi-factor authentication, update firewall rules, patch a software vulnerability, restrict network access permissions), (ii) a remedial action type (e.g., configuration change, security control adjustment, software update), (iii) a priority level, (iv) an applicable framework identifier indicating the source framework (e.g., NIST CSF, SP 800-53, MITRE ATT&CK, CIS benchmarks, HIPAA, GDPR, SOC 2), (v) a target object type (e.g., firewall, router, server, load balancer), (vi) a compliance gap classification (e.g., missing control, misconfigured control, expected-but-missing edge, expected-but-missing node, unexpected node or edge), (vii) an effectiveness score based on historical success rates, (viii) cross-framework mappings indicating conceptually similar controls that are syntactically different, (ix) answers of the Q&A pairs to map the particular controls to plain-language explanations, or other labels associated with the remedial actions.

The first machine learning model 204 may be trained during the first training routine using the first training inputs 202 and first actual outputs 210 described above. The set of first training data may be obtained from a model training database or from the system data 350. For example, the data processing system 306 may retrieve the set of first training data from the system data 350 in response to determining the first machine learning model 204 to be trained. During a first training iteration, the first machine learning model 204 may receive first training inputs 202 comprising network security framework information (e.g., a control specification from NIST SP 800-53), computing object information (e.g., a firewall configuration state), or graph neural network output data (e.g., an indication of a missing but expected relationship between a network security framework control or requirement and a computing object, an indication of a relationship between a network security framework control or requirement and a computing object, etc.). Based on the first training inputs 202, the first machine learning model 204 may generate a first predicted output 206 comprising a predicted remedial action (e.g., update firewall rules to implement the specified control for the computing object). The comparator 208 may compare the predicted remedial action to the target remedial action of the first actual output 210 (e.g., a ground truth remedial action labeled with the remedial action identifier, remedial action type, applicable framework identifier, etc.). Based on the comparison, the comparator 208 may generate an error signal 212 indicating a difference between the predicted remedial action and the target remedial action. The first machine learning model 204 may update one or more configurations (e.g., weighting coefficients, biases, or other parameters) based on the error signal 212 using a backpropagation algorithm to reduce the error. The error signal 212 may be propagated through the algorithmic weights of the first machine learning model 204 such that the weights adapt based on the amount of error, minimizing a loss function (e.g., cross entropy error function) over successive iterations.

During the first training routine, the first machine learning model 204 may learn the relationships between the first training inputs 202 (e.g., network security control information, network security framework identifiers, computing environment object data, graph neural network output information, etc.) and the first actual outputs 210 (e.g., target remedial actions or other targeted data). The first machine learning model 204 may be trained until the error determined at the comparator 208 is within a threshold or a threshold number of iterations have been reached, after which the trained first machine learning model 204 and associated weighting coefficients may be stored in memory 312 for subsequent inference operations.

In some embodiments, the first machine learning model 204 may be fine-tuned during a first fine-tuning training routine. Fine-tune training (or fine-tuning) refers to a training method where a pre-trained (or partially trained) artificial intelligence model, such as a Large Language Model, is adapted for a specific task or use case. For example, fine-tuning may involve providing additional information (e.g., labels, indications of accuracy, evaluation values, prompts, Q&A pairs, annotations, etc.) to a model (e.g., the first machine learning model 204) to generate more accurate, contextualized, domain-specific responses from the model. The data processing system 306 may prepare a first fine-tuning training dataset from network security framework materials, such as NIST CSF and SP 800-53 documents. The first fine-tuning training dataset may include not only raw text from the network security framework documents, but also annotations or Q&A pairs that map particular controls to plain-language explanations, or scenarios classified by control families (e.g., access control, incident response) or function categories (e.g., Identify, Protect, Detect). The first fine-tuning training dataset may further include graph neural network output data, based on the graph neural network processing subgraphs, that may include confidence scores of remedial actions, candidate remedial actions, relationships between network security frameworks and computing objects, indications of missing but expected relationships, or other information. These contextual signals enable the machine learning model 204 to learn associations between security framework terminology, computing environment objects, graph-derived relationship information, and generated remedial actions.

During fine-tuning, the first machine learning model 204 learns to generate outputs (e.g., remedial actions) that mimic the language and guidance of the network security frameworks. For example, given a prompt about cloud security, the machine learning model 204 may generate a remedial action or other recommendation with references to relevant controls and framework guidance of cloud security for a computing environment and the objects thereof. The system may fine-tune the first machine learning model 204 during a first fine-tuning training routine based on evaluation metrics such as, for example, precision of control references, completeness of recommended safeguards, consistency with framework terminology (e.g., NIST terminology), or others related to evaluating generated remedial actions. In some embodiments, a human evaluator (e.g., an expert) or an automated validation process may evaluate the generated remedial actions or recommendations by providing an evaluation value corresponding to each generated remedial action. The evaluation value may be a numerical value, such as a normalized numerical value according to a given scale (0-1, 0-10, 0-100, etc.), a percentage, or other quantitative metric for measuring accuracy.

In response to receiving the evaluation value, the data processing system 306 may cause one or more configurations (e.g., weights, biases, or other parameters) of the first machine learning model 204 to be updated by determining an error signal 212 between the generated recommendation (e.g., remedial action) and the evaluation value, using a backpropagation algorithm to reduce the error. By doing so, the machine learning model 204 may be further trained (e.g., fine-tuned) using quantitative evaluation metrics to better generate remedial actions aligned with network security frameworks. If the first machine learning model 204 suggests actions that conflict with the network security frameworks or misses key points, the data processing system 306 may iteratively refine the training data and repeat the fine-tuning process. Successful fine-tuning may be indicated by the first machine learning model 204 producing high-quality, network security framework-aligned remedial actions that address cybersecurity vulnerabilities based on multiple network security frameworks and computing environment-specific information.

As another example, a second machine learning model 204 may be a graph neural network model trained to generate outputs related to remedial actions for cybersecurity vulnerabilities. For example, the second machine learning model 204 may generate remedial actions, recommendations, indications of relationships between network security framework information and computing object information, confidence scores of generated remedial actions, or other information. For example, the second machine learning model 204 may be trained during a second training routine. The second machine learning model 204 may be trained on a set of second training data (e.g., second training inputs 202, second actual outputs 210, etc.). The set of second training data may include second training inputs 202 that indicate graph-based information.

The graph-based information may include subgraphs, historical subgraphs, main-graphs, or portions thereof corresponding to network security frameworks and computing environment objects. The graphs or subgraphs may include nodes corresponding to network security frameworks, nodes corresponding to computing objects, and edges connecting the nodes of the graphs. The nodes corresponding to network security frameworks may include network security framework information, a vector embedding of a chunk of network security framework information, framework identifiers, control identifiers, function categories, risk assessments, family classifications, or other information. The nodes corresponding to computing objects may include a vector embedding of the computing object, type classifications (e.g., firewall, router, server, load balancer), object identifiers, state information indicating current configurations or operational statuses, platform associations, log information, or other information. The edges connecting the nodes of the graphs may include relationship information between the nodes, such as indications of missing but expected relationships between nodes, indications of unexpected nodes or edges within subgraphs, or other information.

The relationship information may indicate associations (i) between network security framework controls or requirements and computing objects within a computing environment or (ii) between one network security framework and other network security framework. For example, a relationship may indicate that a particular firewall object is subject to a NIST SP 800-53 access control requirement specifying network traffic filtering rules. As another example, a relationship may indicate that a server object is associated with a CIS benchmark control requiring specific hardening configurations for the operating system. In another example, a relationship may indicate that a router object is linked to a MITRE ATT&CK technique describing lateral movement tactics that the router configuration should mitigate. As a further example, a relationship may indicate that a load balancer object is connected to a HIPAA requirement mandating encryption of data in transit for protected health information. The relationship information may also indicate that a database server object is associated with a GDPR requirement specifying data protection measures for personal data storage.

The set of second training data may also include second actual outputs 210 that indicate target graph-based outputs to be generated based on the second training inputs 202. Such second actual outputs 210 may serve as ground truth information for training the second machine learning model 204 and may be labeled with (i) candidate remedial actions derived from graph analysis, (ii) confidence scores for the candidate remedial actions, (iii) indications of expected-but-missing edges between nodes of the subgraph, (iv) indications of expected-but-missing nodes within the subgraph, (v) indications of unexpected nodes or edges within the subgraph, (vi) inferred connections between nodes that represent conceptually similar controls that are syntactically different across different security frameworks, (vii) gap identifications indicating compliance gaps in controls or requirements of security frameworks respective to computing objects of a computing environment, (viii) cross-framework relationship mappings, or other labels associated with the graph-based outputs.

The second machine learning model 204 may be trained during the second training routine using the second training inputs 202 and second actual outputs 210 described above. The set of second training data may be obtained from a model training database or from the system data 350. For example, the data processing system 306 may retrieve the set of second training data from the system data 350 in response to determining the second machine learning model 204 to be trained. During a second training iteration, the second machine learning model 204 may receive second training inputs 202. Based on the second training inputs 202, the second machine learning model 204 may generate a second predicted output 206 comprising predicted candidate remedial actions or predicted confidence scores for the candidate remedial actions, an indication of an expected-but-missing edge between nodes, or other information. The comparator 208 may compare the predicted candidate remedial actions, predicted confidence scores, or the expected-but-missing edge predictions, to the target graph-based outputs of the second actual output 210 (e.g., ground truth candidate remedial actions, ground truth confidence scores, ground truth indications of missing relationships, etc.). Based on the comparison, the comparator 208 may generate an error signal 212 indicating a difference between the predicted graph-based outputs and the target graph-based outputs. The second machine learning model 204 may update one or more configurations (e.g., weighting coefficients, biases, or other parameters) based on the error signal 212 using a backpropagation algorithm to reduce the error. The error signal 212 may be propagated through the algorithmic weights of the second machine learning model 204 such that the weights adapt based on the amount of error, minimizing a loss function (e.g., mean squared error function for confidence score prediction, cross entropy error function for relationship classification) over successive iterations.

During the second training routine, the second machine learning model 204 may learn patterns within the subgraphs and infer connections between nodes that may not be explicitly preserved in the subgraph, including connections between conceptually similar controls that are syntactically different across different security frameworks. The second machine learning model 204 may learn to identify gaps in controls or requirements of security frameworks respective to computing objects of a computing environment based on the relationships between the second training inputs 202 (e.g., graph data structures, nodal information including framework identifiers and control identifiers, edge information including relationship associations between framework controls and computing objects, historical subgraph patterns, etc.) and the second actual outputs 210 (e.g., target candidate remedial actions, target confidence scores, target relationship inferences, etc.). The second machine learning model 204 may be trained until the error determined at the comparator 208 is within a threshold or a threshold number of iterations have been reached, after which the trained second machine learning model 204 and associated weighting coefficients may be stored in memory 312 for subsequent inference operations.

As another example, a third machine learning model 204 may be a validation large language model trained to validate remedial actions and evaluate completeness of remedial actions. For instance, the third machine learning model 204 may be used to validate remedial actions outputted from the first machine learning model 204 or remedial actions derived from the second machine learning model 204 (e.g., the graph neural network). The third machine learning model 204 may be configured to determine whether a remedial action satisfies an acceptance criteria and, responsive to determining that the remedial action is incomplete, automatically trigger one or more actions (e.g., an additional iteration of querying the graph data structure and generating the subgraph to obtain additional controls, requirements, or objects omitted from a prior iteration). In some embodiments, the third machine learning model 204 may be a RAG model that is communicatively coupled with one or more databases (e.g., vector database 342, graph database 348, etc.) or one or more retrievers (e.g., retriever 320, graph data retriever 330, etc.) to retrieve information from the one or more databases as context when generating an output (e.g., a remedial action, a recommendation, a response, etc.).

In some embodiments, the third machine learning model 204 may be trained during a third training routine. The third machine learning model 204 may be trained on a set of third training data (e.g., third training inputs 202, third actual outputs 210, etc.) to train the third machine learning model to validate remedial actions generated by the first machine learning model 204 using graph neural network output data and acceptance criteria. The set of third training data may include third training inputs 202 that indicate graph neural network output information, remedial action information, and acceptance criteria information. The graph neural network output information may include outputs generated by the second machine learning model 204 (e.g., the graph neural network) based on processing subgraphs. The graph neural network output information may include candidate remedial actions generated by the graph neural network, confidence scores for the candidate remedial actions, inferred connections between nodes representing conceptually similar controls that are syntactically different across different security frameworks, and gap identifications indicating compliance gaps in controls or requirements of security frameworks respective to computing objects. The graph neural network output information may further include indications of expected-but-missing edges between nodes, indications of expected-but-missing nodes, indications of unexpected nodes or edges, or other information derived from the graph neural network processing.

The remedial action information may include remedial action identifiers, remedial action types (e.g., configuration change, security control adjustment, software update), target object types, applicable framework identifiers, and confidence scores associated with the remedial actions. The acceptance criteria information may include completeness criteria such as coverage of one or more applicable security framework controls identified in the graph neural network outputs, addressing of one or more expected-but-missing edges or nodes identified by the graph neural network, inclusion of remedial actions for each computing object associated with relevant framework controls in the graph neural network outputs, consistency with cross-framework mappings for conceptually similar controls that are syntactically different, alignment with function categories and control families of the applicable security frameworks, and addressing of one or more compliance gaps identified by the graph neural network relative to the computing environment objects.

The set of third training data may also include third actual outputs 210 that indicate target validation determinations to be generated based on the third training inputs 202. Such third actual outputs 210 may serve as ground truth information for training the third machine learning model 204 and may be labeled with (i) a validation determination (e.g., complete, incomplete, partially complete), (ii) a completeness score indicating a degree to which the remedial action addresses the graph neural network outputs, (iii) an identification of missing controls or requirements not addressed by the remedial action, (iv) an identification of computing objects not covered by the remedial action, (v) an identification of expected-but-missing relationships not addressed by the remedial action, (vi) an indication of whether additional iterations are required, (vii) a specification of additional controls, requirements, or objects to be obtained in subsequent iterations, or other labels associated with the validation determinations.

The third machine learning model 204 may be trained during the third training routine using the third training inputs 202 and third actual outputs 210 described above. The set of third training data may be obtained from a model training database or from the system data 350. For example, the data processing system 306 may retrieve the set of third training data from the system data 350 in response to determining the third machine learning model 204 to be trained. During a third training iteration, the third machine learning model 204 may receive third training inputs 202 including graph neural network output information (e.g., outputs generated from the second machine learning model 204), remedial action information (e.g., a remedial action generated by the first machine learning model 204 to update firewall rules based on the graph neural network outputs), acceptance criteria information (e.g., criteria requiring coverage of all access control requirements identified in the graph neural network outputs), or other information. Based on the third training inputs 202, the third machine learning model 204 may generate a third predicted output 206 comprising a predicted validation determination. The comparator 208 may compare the predicted validation determination to the target validation determination of the third actual output 210 (e.g., a ground truth validation determination). Based on the comparison, the comparator 208 may generate an error signal 212 indicating a difference between the predicted validation determination and the target validation determination. The third machine learning model 204 may update one or more configurations (e.g., weighting coefficients, biases, or other parameters) based on the error signal 212 using a backpropagation algorithm to reduce the error. The error signal 212 may be propagated through the algorithmic weights of the third machine learning model 204 such that the weights adapt based on the amount of error, minimizing a loss function (e.g., cross entropy error function for validation classification, mean squared error for completeness scoring) over successive iterations.

During the third training routine, the third machine learning model 204 may learn the relationships between the third training inputs 202 (e.g., graph neural network output information derived from the second machine learning model 204, remedial action information generated by the first machine learning model 204, acceptance criteria information, etc.) and the third actual outputs 210 (e.g., target validation determinations). The third machine learning model 204 may be trained until the error determined at the comparator 208 is within a threshold or a threshold number of iterations have been reached, after which the trained third machine learning model 204 and associated weighting coefficients may be stored in memory 312 for subsequent inference operations.

In some embodiments, the third machine learning model 204 may be fine-tuned during a third fine-tuning training routine to validate remedial actions generated via the first machine learning model 204 using outputs from the second machine learning model 204 (e.g., the graph neural network). The data processing system 306 may prepare a third fine-tuning training dataset from historical validation scenarios, including graph neural network outputs, remedial actions generated by the first machine learning model 204, and expert-labeled validation determinations. The third fine-tuning training dataset may include annotations indicating which remedial actions were determined to be complete or incomplete based on the graph neural network outputs, reasons for incompleteness determinations, and specifications of additional controls, requirements, or objects that were obtained in subsequent iterations to achieve completeness. The third fine-tuning training dataset may further include graph neural network output data such as candidate remedial actions, confidence scores, inferred connections between nodes, and gap identifications to enable the third machine learning model 204 to learn associations between graph neural network-derived information and validation determinations.

During fine-tuning, the third machine learning model 204 learns to evaluate completeness of remedial actions generated by the first machine learning model 204 relative to the graph neural network outputs and determine whether remedial actions satisfy acceptance criteria. For example, given a remedial action generated by the first machine learning model 204 and corresponding graph neural network outputs from the second machine learning model 204, the third machine learning model 204 may generate a validation determination indicating whether the remedial action addresses all applicable controls, requirements, and computing objects identified in the graph neural network outputs. The system may fine-tune the third machine learning model 204 during a third fine-tuning training routine based on evaluation metrics such as, for example, accuracy of completeness determinations relative to graph neural network outputs, precision in identifying missing controls or objects based on the graph neural network-identified gaps, recall in detecting incomplete remedial actions, or others related to evaluating validation determinations. In some embodiments, a human evaluator (e.g., an expert) or an automated validation process may evaluate the validation determinations by providing an evaluation value corresponding to each validation determination. The evaluation value may be a numerical value, such as a normalized numerical value according to a given scale (0-1, 0-10, 0-100, etc.), a percentage, or other quantitative metric for measuring accuracy.

In response to receiving the evaluation value, the data processing system 306 may cause one or more configurations (e.g., weights, biases, or other parameters) of the third machine learning model 204 to be updated by determining an error signal 212 between the generated validation determination and the evaluation value, using a backpropagation algorithm to reduce the error. By doing so, the third machine learning model 204 may be further trained (e.g., fine-tuned) using quantitative evaluation metrics to better evaluate completeness of remedial actions relative to graph neural network outputs. If the third machine learning model 204 incorrectly determines a remedial action to be complete when the graph neural network outputs indicate missing controls or gaps, or incorrectly determines a remedial action to be incomplete when all requirements identified in the graph neural network outputs are addressed, the data processing system 306 may iteratively refine the training data and repeat the fine-tuning process. Successful fine-tuning may be indicated by the third machine learning model 204 producing accurate validation determinations that correctly identify incomplete remedial actions based on graph neural network outputs and trigger additional iterations to obtain omitted controls, requirements, or objects.

In some embodiments, the third machine learning model 204 may be trained on a set of fourth training data to validate remedial actions from the second machine learning model 204 (e.g., the graph neural network) relative to a subgraph. The set of fourth training data may include fourth training inputs 202 that indicate subgraph information, graph neural network output information, remedial action information, and acceptance criteria information. The subgraph information may include the subgraph used as input to the second machine learning model 204 (e.g., the graph neural network), including nodes corresponding to controls or requirements of network security frameworks, nodes corresponding to computing objects of a computing environment, and the edges linking the nodes. The nodes corresponding to network security frameworks may include network security framework information, a vector embedding of a chunk of network security framework information, framework identifiers, control identifiers, function categories, risk assessments, family classifications, or other information. The nodes corresponding to computing objects may include a vector embedding of the computing object, type classifications (e.g., firewall, router, server, load balancer), object identifiers, state information indicating current configurations or operational statuses, platform associations, log information, or other information. The edges connecting the nodes of the graphs may include relationship information between the nodes, such as indications of missing but expected relationships between nodes, indications of unexpected nodes or edges within subgraphs, or other information. The acceptance criteria information may include completeness criteria such as coverage of one or more applicable security framework controls identified in the graph neural network outputs, addressing of one or more expected-but-missing edges or nodes identified by the graph neural network, inclusion of remedial actions for each computing object associated with relevant framework controls in the graph neural network outputs, consistency with cross-framework mappings for conceptually similar controls that are syntactically different, alignment with function categories and control families of the applicable security frameworks, addressing of one or more compliance gaps identified by the graph neural network relative to the computing environment objects, or other acceptance criteria.

The graph neural network output information may further include indications of expected-but-missing edges between nodes of the subgraph, indications of expected-but-missing nodes within the subgraph, indications of unexpected nodes or edges within the subgraph, or other information derived from the graph neural network processing of the subgraph. The remedial action information may include remedial action identifiers, remedial action types (e.g., configuration change, security control adjustment, software update), target object types, applicable framework identifiers, and confidence scores associated with the remedial actions derived from the second machine learning model 204.

The set of fourth training data may also include fourth actual outputs 210 that indicate target validation determinations for the graph neural network outputs relative to the subgraph and the acceptance criteria. Such fourth actual outputs 210 may serve as ground truth information for training the third machine learning model 204 and may be labeled with (i) a validation determination (e.g., complete, incomplete, partially complete) indicating whether the candidate remedial actions adequately address the relationships and gaps identified in the subgraph and satisfy the acceptance criteria, (ii) a completeness score indicating a degree to which the remedial actions address the nodes, edges, and relationships within the subgraph relative to the acceptance criteria, (iii) an identification of nodes corresponding to network security frameworks from the subgraph not addressed by the remedial actions, (iv) an identification of nodes corresponding to computing objects from the subgraph not covered by the remedial actions, (v) an identification of edges or relationships within the subgraph not addressed by the remedial actions, (vi) an indication of whether additional iterations are required to expand the subgraph based on the acceptance criteria evaluation, (vii) a specification of additional controls, requirements, or objects to be obtained in subsequent iterations based on the subgraph analysis and acceptance criteria, or other labels associated with the validation determinations relative to the subgraph and acceptance criteria.

The third machine learning model 204 may be trained during a fourth training routine using the fourth training inputs 202 and fourth actual outputs 210 described above. The set of fourth training data may be obtained from a model training database or from the system data 350. For example, the data processing system 306 may retrieve the set of fourth training data from the system data 350 in response to determining the third machine learning model 204 to be trained for validating graph neural network outputs relative to subgraphs and acceptance criteria. During a fourth training iteration, the third machine learning model 204 may receive fourth training inputs 202 including subgraph information (e.g., the subgraph including nodes corresponding to network security frameworks and nodes corresponding to computing objects with their associated edges), graph neural network output information (e.g., candidate remedial actions and confidence scores generated by the second machine learning model 204 based on processing the subgraph), remedial action information (e.g., a candidate remedial action to update firewall rules derived from the graph neural network analysis of the subgraph), and acceptance criteria information (e.g., criteria requiring coverage of all access control requirements identified in the graph neural network outputs). Based on the fourth training inputs 202, the third machine learning model 204 may generate a fourth predicted output 206 comprising a predicted validation determination indicating whether the candidate remedial actions adequately address the subgraph and satisfy the acceptance criteria. The comparator 208 may compare the predicted validation determination to the target validation determination of the fourth actual output 210 (e.g., a ground truth validation determination relative to the subgraph and acceptance criteria). Based on the comparison, the comparator 208 may generate an error signal 212 indicating a difference between the predicted validation determination and the target validation determination. The third machine learning model 204 may update one or more configurations (e.g., weighting coefficients, biases, or other parameters) based on the error signal 212 using a backpropagation algorithm to reduce the error. The error signal 212 may be propagated through the algorithmic weights of the third machine learning model 204 such that the weights adapt based on the amount of error, minimizing a loss function (e.g., cross entropy error function for validation classification, mean squared error for completeness scoring relative to subgraph coverage and acceptance criteria satisfaction) over successive iterations.

During the fourth training routine, the third machine learning model 204 may learn the relationships between the fourth training inputs 202 (e.g., subgraph information including nodes corresponding to network security frameworks and nodes corresponding to computing objects, graph neural network output information derived from the second machine learning model 204 processing the subgraph, remedial action information, acceptance criteria information, etc.) and the fourth actual outputs 210 (e.g., target validation determinations relative to the subgraph and acceptance criteria). By having direct access to the subgraph and acceptance criteria, the third machine learning model 204 may learn to evaluate whether the candidate remedial actions generated by the second machine learning model 204 adequately address all nodes corresponding to network security frameworks, nodes corresponding to computing objects, and edges within the subgraph, and whether the remedial actions satisfy the acceptance criteria. The third machine learning model 204 may be trained until the error determined at the comparator 208 is within a threshold or a threshold number of iterations have been reached, after which the trained third machine learning model 204 and associated weighting coefficients may be stored in memory 312 for subsequent inference operations involving validation of graph neural network outputs relative to subgraphs and determination of whether remedial actions satisfy the acceptance criteria.

In some embodiments, the third machine learning model 204 may be fine-tuned during a fourth fine-tuning training routine to validate remedial actions generated from the second machine learning model 204 (e.g., the graph neural network) relative to a subgraph. The data processing system 306 may prepare a fourth fine-tuning training dataset from historical validation scenarios, including subgraphs used as input to the second machine learning model 204 (e.g., the graph neural network), graph neural network outputs generated from processing the subgraphs, remedial actions generated from the graph neural network outputs, expert-labeled validation determinations, acceptance criteria, or other information. The fourth fine-tuning training dataset may include the subgraphs with their nodes corresponding to controls or requirements of network security frameworks, nodes corresponding to computing objects of a computing environment, and the edges linking the nodes. The fourth fine-tuning training dataset may include annotations indicating which remedial actions were determined to be complete or incomplete based on the subgraph and the graph neural network outputs, reasons for incompleteness determinations relative to the subgraph structure, and specifications of additional controls, requirements, or objects that were obtained in subsequent iterations to expand the subgraph and achieve completeness. The fourth fine-tuning training dataset may further include acceptance criteria information such as completeness criteria requiring coverage of applicable security framework controls identified in the subgraph, addressing of expected-but-missing edges or nodes identified by the graph neural network, inclusion of remedial actions for each computing object associated with relevant framework controls in the subgraph, and consistency with cross-framework mappings for conceptually similar controls that are syntactically different. The fourth fine-tuning training dataset may also include graph neural network output data such as candidate remedial actions, confidence scores, inferred connections between nodes, and gap identifications to enable the third machine learning model 204 to learn associations between subgraph structure, graph neural network-derived information, acceptance criteria, and validation determinations.

During fine-tuning, the third machine learning model 204 learns to evaluate completeness of remedial actions generated from the second machine learning model 204 (e.g., the graph neural network) relative to the subgraph and determine whether remedial actions satisfy acceptance criteria. By having direct access to the subgraph, the third machine learning model 204 may learn to evaluate whether the candidate remedial actions adequately address all nodes corresponding to network security frameworks, nodes corresponding to computing objects, and edges within the subgraph. For example, given a subgraph including nodes corresponding to network security frameworks and nodes corresponding to computing objects with their associated edges, graph neural network outputs from the second machine learning model 204 processing the subgraph, and acceptance criteria information, the third machine learning model 204 may generate a validation determination indicating whether the remedial action addresses all applicable controls, requirements, and computing objects identified in the subgraph and whether the remedial action satisfies the acceptance criteria. The system may fine-tune the third machine learning model 204 during a fourth fine-tuning training routine based on evaluation metrics such as, for example, accuracy of completeness determinations relative to subgraph coverage and acceptance criteria satisfaction, precision in identifying nodes corresponding to network security frameworks or nodes corresponding to computing objects from the subgraph not addressed by the remedial actions, recall in detecting incomplete remedial actions based on the subgraph structure, or others related to evaluating validation determinations relative to the subgraph and acceptance criteria. In some embodiments, a human evaluator (e.g., an expert) or an automated validation process may evaluate the validation determinations by providing an evaluation value corresponding to each validation determination. The evaluation value may be a numerical value, such as a normalized numerical value according to a given scale (0-1, 0-10, 0-100, etc.), a percentage, or other quantitative metric for measuring accuracy.

In response to receiving the evaluation value, the data processing system 306 may cause one or more configurations (e.g., weights, biases, or other parameters) of the third machine learning model 204 to be updated by determining an error signal 212 between the generated validation determination and the evaluation value, using a backpropagation algorithm to reduce the error. By doing so, the third machine learning model 204 may be further trained (e.g., fine-tuned) using quantitative evaluation metrics to better evaluate completeness of remedial actions relative to the subgraph and acceptance criteria. If the third machine learning model 204 incorrectly determines a remedial action to be complete when the subgraph and graph neural network outputs indicate missing controls, gaps, or unaddressed nodes or edges, or incorrectly determines a remedial action to be incomplete when all nodes corresponding to network security frameworks, nodes corresponding to computing objects, and edges within the subgraph are addressed and the acceptance criteria are satisfied, the data processing system 306 may iteratively refine the training data and repeat the fine-tuning process. Successful fine-tuning may be indicated by the third machine learning model 204 producing accurate validation determinations that correctly identify incomplete remedial actions based on the subgraph structure and graph neural network outputs, determine whether remedial actions satisfy the acceptance criteria, and trigger additional iterations to expand the subgraph and obtain omitted controls, requirements, or objects.

Referring to FIG. 2B, a block diagram of a simplified neural network model 200B is shown. The neural network model 200B is only an example architecture. The neural network 200B can be any type of neural network, such as a feedforward neural network, a recurrent neural network, a convolutional neural network, a long short-term memory neural network, graph neural network, deep neural network, etc. The neural network model 200B may include a stack of distinct layers (vertically oriented) that transform a variable number of inputs 214 being ingested by an input layer 216 into an output 218 at the output layer 220.

The neural network model 200B may include a number of hidden layers 222 between the input layer 216 and output layer 220. Each hidden layer has a respective number of nodes (224, 226, and 228). In the neural network model 200B, the first hidden layer 222-1 has nodes 224, and the second hidden layer 222-2 has nodes 226. The nodes 224 and 226 perform a particular computation and are interconnected to the nodes of adjacent layers (e.g., nodes 224 in the first hidden layer 222-1 are connected to nodes 226 in a second hidden layer 222-2, and nodes 226 in the second hidden layer 222-2 are connected to nodes 228 in the output layer 220). Each of the nodes (224, 226, and 228) sum up the values from adjacent nodes and apply an activation function, allowing the neural network model 200B to detect nonlinear patterns in the inputs 214. Each of the nodes (224, 226, and 228) are interconnected by weights 230-1, 230-2, 230-3, 230-4, 230-5, 230-6 (collectively referred to as weights 230). Weights 230 are tuned during training to adjust the strength of the node. The adjustment of the strength of the node facilitates the neural network's ability to predict an accurate output 218.

In some embodiments, the output 218 may be one or more numbers. For example, output 218 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As such, the softmax classifier may be employed because of the classifier's ability to classify various classes. Other classifiers may be used to make other classifications. For example, the sigmoid function makes binary determinations about the classification of one class (i.e., the output may be classified using label A or the output may not be classified using label A).

### C. Computing Device and Graph Data Structures Used for Generating Remedial Actions to Cyber Security Vulnerabilities

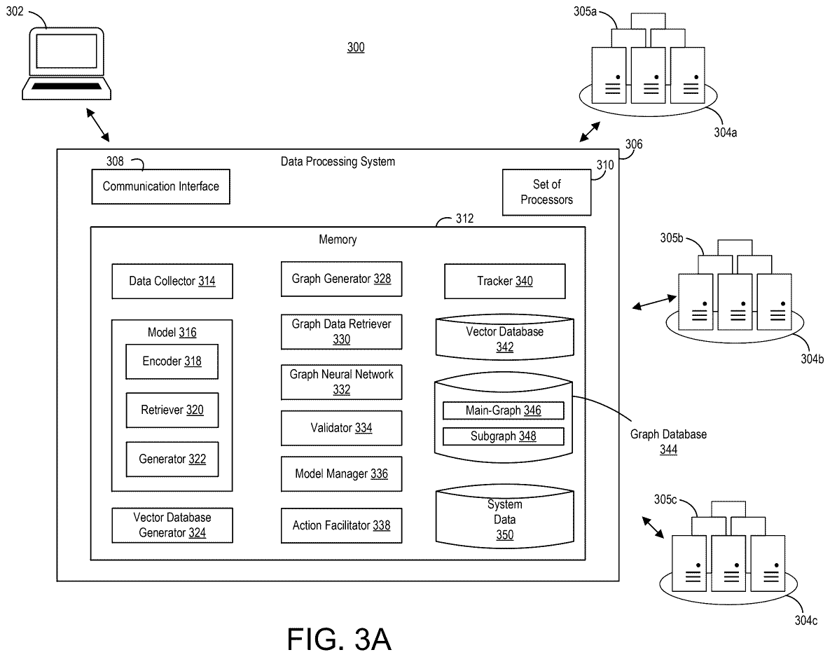

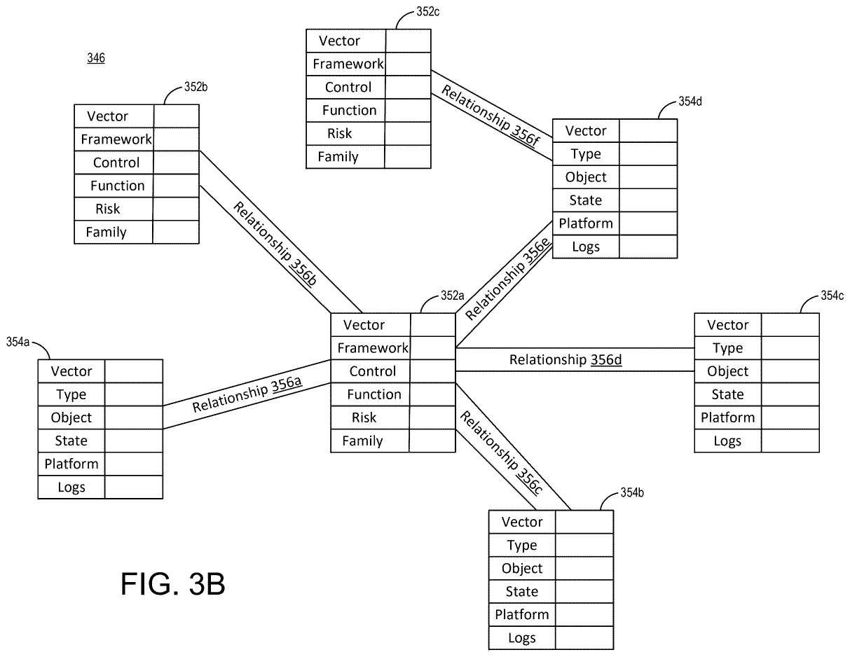

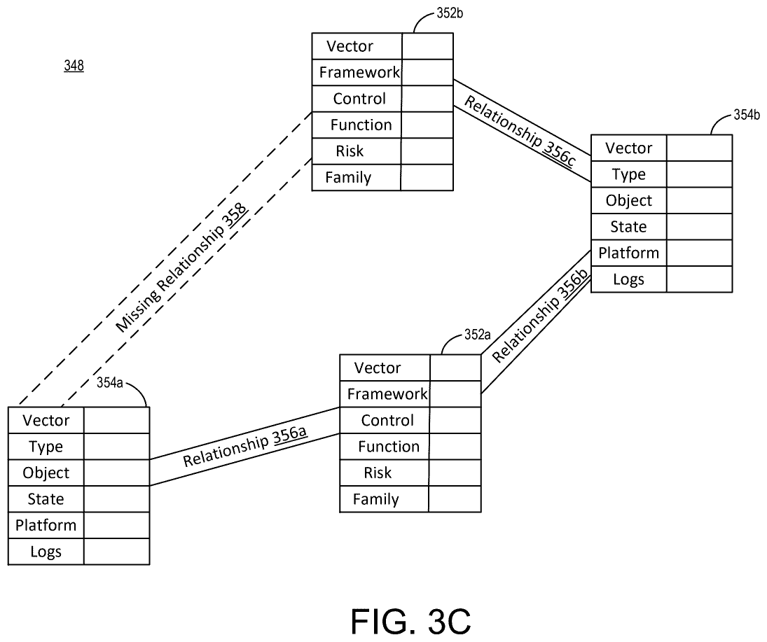

FIG. 3A is an illustration of an example system 300 for facilitating remedial actions to cybersecurity vulnerabilities, in accordance with an implementation. In brief overview, the example system 300 can include a client device 302, computing environments 304a-304c (including one or more computing objects 305a-305c), and a data processing system 306. The system 300 can include more or fewer components than illustrated in FIG. 3A, depending on the implementation. Each of the computing devices can be configured to store various types of data and perform various types of operations discussed in this disclosure. The data processing system 306 can perform one or more operations associated with generating, implementing, revising, or providing remedial actions or other recommendations for cyber security vulnerabilities.

The client device 302 can be an electronic computing device (e.g., a cellular phone, a laptop, a tablet, a personal computer, or any other type of computing device). The client device 302 can include a display with a microphone, a speaker, a keyboard, a touchscreen, or any other type of input/output device. A user can access a platform provided by the data processing system 306 through the client device 302 to interact with one or more models (e.g., LLMs, GNNs, NNs, etc.), view outputs of models (e.g., remedial actions, recommendations, etc.), query databases, view graph data, manage computing environments, or other user-interface related processes as described herein.

For example, the client device 302 may present a user interface that enables users to submit natural language queries requesting information about different network security frameworks as related to objects of a computing environment. The client device 302 may also receive and display indications of remedial actions generated by the data processing system 306, including recommendations for addressing gaps in controls or requirements of applicable security frameworks with respect to computing objects within the computing environments 304a-304c. Furthermore, the client device 302 may enable users to select which network security frameworks are applicable to their organization and view dynamic reports generated through natural language inputs.

Computing environments 304a-304c may be or correspond to networked computing infrastructures associated with one or more entities, such as organizations, enterprises, or other business units. The computing environments 304a-304c may be managed by cybersecurity experts, information technology administrators, security operations center personnel, or other authorized users responsible for maintaining the security posture of the respective computing environments. For example, a user may manage the computing environments 304a-304c (or computing objects 305a-305c) using client device 302. In other embodiments, the computing environments 304a-304c may be used as information sources to provide information related to real-time (or near real-time) cybersecurity vulnerabilities, computing object 305a-305c information, configuration states, security events, compliance status, or other operational data relevant to generating remedial actions.

Each of the computing environments 304a-304c may include one or more computing objects 305a-305c that represent components, devices, or resources within the respective computing environment. The computing environments 304a-304c may be implemented as on-premises data centers, cloud-based infrastructures, hybrid computing environments, or distributed computing systems spanning multiple geographic locations. The computing environments 304a-304c may be subject to various network security frameworks, compliance requirements, and regulatory standards that govern the configuration and operation of the computing objects 305a-305c within each respective environment. For example, a first computing environment 304a may be associated with a first network security framework such as NIST CSF and a second computing environment 304b may be associated with a second network security framework such as HIPAA or GDPR. As another example, however, a given computing environment 304 may be associated with multiple network security frameworks simultaneously, such as when an organization must comply with both industry-specific regulations (e.g., HIPAA for healthcare data) and general cybersecurity standards (e.g., NIST SP 800-53 for federal information systems). The data processing system 306 can leverage the techniques described herein to identify applicable controls and requirements across these different frameworks and generate remedial actions that address compliance gaps across multiple frameworks concurrently, thereby enabling organizations to maintain a comprehensive security posture that satisfies diverse regulatory and operational requirements.

The computing objects 305a-305c may include, for example, firewalls, routers, switches, servers, load balancers, intrusion detection systems, intrusion prevention systems, endpoint devices, virtual machines, containers, network segments, databases, storage systems, authentication servers, domain controllers, web application firewalls, proxy servers, VPN gateways, computing devices, computers, desktop computers, laptop computers, workstations, personal computers, mobile devices, smartphones, tablets, wearable devices, embedded systems, Internet of Things (IoT) devices, printers, multifunction devices, scanners, network-attached storage (NAS) devices, storage area network (SAN) components, backup systems, modems, gateways, bridges, hubs, repeaters, protocol converters, terminal servers, thin clients, zero clients, kiosks, point-of-sale terminals, programmable logic controllers, building automation systems, security cameras, access control systems, badge readers, biometric authentication devices, voice over IP (VoIP) phones, video conferencing systems, digital signage systems, smart televisions, gaming consoles, streaming devices, network appliances, unified threat management devices, network monitoring tools, packet capture devices, container runtime environments, DNS servers, DHCP servers, key management systems, hardware security modules, or other network infrastructure components, peripheral devices, or computing equipment that may be connected together in a computing network.

As noted above, while only one computing object is shown in FIG. 3A for each computing environment 304, it will be appreciated that each computing environment 304a-304c may include multiple computing objects 305. The computing objects 305a-305c may be configured to transmit real-time data to the data processing system 306, including configuration states, security event logs, vulnerability scan results, compliance assessment data, network traffic patterns, authentication logs, access control configurations, software version information, patch status, and other operational telemetry. The data processing system 306 may receive this real-time data from the computing objects 305a-305c via the communication interface 308 and use the received data to generate remedial actions or other recommendations with current information about the computing environment. By continuously receiving real-time data from the computing objects 305a-305c, the data processing system 306 can generate remedial actions that are tailored to the current state of the computing environment, identify emerging vulnerabilities as they arise, and provide recommendations that account for the specific configurations and operational characteristics of the computing objects 305a-305c. This real-time data integration enables the data processing system 306 to generate context-aware remedial actions that address not only static compliance requirements from network security frameworks but also dynamic security conditions within the computing environments 304a-304c.

The data processing system 306 may include one or more processors that are configured to perform operations associated with generating, implementing, revising, or providing remedial actions or other recommendations for cybersecurity vulnerabilities. The data processing system 306 may include a communication interface 308, a set of processors 310, and a memory 312. The data processing system 306 may communicate with the computing environments 304a-304c, the computing objects 305a-305c, the client device 302, or other components via the communication interface 308, which may be or include an antenna or other network device that enables communication across a network and/or with other devices. The memory 312 may include a data collector 314, a model 316 that includes an encoder 318, a retriever 320, and a generator 322, a vector database generator 324, a graph generator 328, a graph data retriever 330, a graph neural network 332, a validator 334, a model manager 336, an action facilitator 338, a tracker 340, a vector database 342, a graph database 344 that includes a main-graph 346 and subgraph 348, and system data 350.

The set of processors 310 may be or include an application-specific integrated circuit (ASIC), a set of field programmable gate arrays (FPGAs), a set of digital signal processors (DSPs), circuits containing one or more processing components, circuitry for supporting a microprocessor, a group of processing components, or other suitable electronic processing components. In some embodiments, the set of processors 310 may execute computer code or modules (e.g., executable code, object code, source code, script code, machine code, etc.) stored in the memory 312 to facilitate the operations described herein. The memory 312 may be or include any volatile or non-volatile computer-readable storage medium capable of storing data or computer code.

One or more of the computing environments 304, computing objects 305, or the data processing system 306 can include or utilize at least one processing unit or other logic devices such as a programmable logic array engine or a module configured to communicate with one another or other resources or databases to perform one or more of the operations described in this disclosure. As described herein, computers can be described as computers, computer devices, computing devices, or client devices. One or more of the computing environments 304 or computing objects 305 may each contain their own computer resources (e.g., processor, memory, etc.), share computer resources, or be part of a distributed computer system. The components of the computing environments 304, computing objects 305, or the data processing system 306 can be separate components or a single component. The example system 300 and its components can include hardware elements, such as one or more processors, logic devices, or circuits. One or more of the computing environments 304, computing objects 305, or the data processing system 306 can each store information in memory (e.g., in a database in memory), where such media may include non-transitory machine-readable media used to store program instructions for performing one or more operations described in this disclosure.

The data collector 314 may include instructions that, when executed by the set of processors 310, cause the set of processors 310 to aggregate and retrieve or receive data from different sources, such as the computing environments 304a-304c, the computing objects 305a-305c, the client device 302, the Internet, databases, network security framework administrators, entities, or organizations.

For example, the data collector 314 may access the Internet via the communication interface 308 to retrieve or receive electronic documents corresponding to network security frameworks. The electronic documents corresponding to network security frameworks may provide a structured approach for managing and reducing cybersecurity risk of one or more computing environments 304 or one or more computing objects 305. Such electronic documents may correspond to different network security frameworks. The electronic documents corresponding to the network security frameworks may be pushed from network security framework administrators (e.g., NITS, MITRE, etc.), security advisory entities, or other cybersecurity organizations. Such administrators, entities, or other organizations may push updated network security framework information to data collector 314, such as updated guidance documents, control specifications, or security advisories (e.g., NIST publishing updates to SP 800-53 controls, MITRE releasing new ATT&CK techniques, or CIS publishing revised benchmark configurations). The data collector 314 may perform such operations by implementing various retrieval methods such as polling, change data capture (CDC), webhook subscriptions, or event-driven mechanisms to fetch real-time data updates from administrators, entities, or other organizations. For example, the data collector 314 employ message queues such as Apache Kafka or RabbitMQ to buffer incoming data streams and prevent data loss during high-volume periods.

In some embodiments, the data collector 314 may identify the electronic documents corresponding to network security frameworks. The data collector 314 may identify electronic documents based on document identifiers, metadata tags, file naming conventions, header information, or source information indicating the associated network security framework (e.g., NIST CSF, SP 800-53, MITRE ATT&CK, CIS benchmarks, HIPAA, GDPR, SOC 2). In some embodiments, the data collector 314 may apply natural language processing techniques, such as text classification models trained on labeled network security framework documents, to classify documents according to their corresponding network security frameworks. By identifying the electronic documents corresponding to network security frameworks, the data collector 314 can ensure accurate categorization and indexing of the documents within the system data 350, thereby facilitating efficient retrieval of framework-specific information during subsequent processing operations.

As another example, the data collector 314 may retrieve or receive computing object data from the computing objects 305a-305c and computing environments 304a-304c. For example, the data collector 314 may establish persistent connections with the computing objects 305a-305c using protocols such as WebSockets, gRPC streaming, MQTT, or other pushed or pulled data protocols to receive computing object data from the computing objects 305a-305c. The computing object data may include event logs, configuration profiles, vulnerability scan results, authentication logs, network traffic information, compliance assessment data, access control lists, firewall rules, intrusion detection alerts, software version information, state information, platform information, patch installation status, certificate expiration notifications, user privilege escalation events, failed login attempts, port scanning activity, malware detection alerts, system resource utilization metrics, backup completion status, encryption key rotation events, API access logs, session timeout events, geolocation data, assigned Internet Protocol or other communication address information, timestamps corresponding to the computing object data, device health attestation results, identity and access management data, user permissions, product information, function information, network segmentation configurations, OS-level patch management data, security policy configurations, or other data of one or more computing objects 305a-305c.

Such protocols may push computing object data from the computing objects 305a-305c to the data collector 314 via one or more streamed processing frameworks to ingest and process real-time data feeds. The data collector 314 may receive push notifications from the computing objects 305a-305c when configuration changes occur, security events are detected, or compliance status changes, enabling the data processing system 306 to maintain current awareness of the security posture of the computing environments 304a-304c. In other embodiments, however, such protocols may be configured for data collector 314 to pull computing object data from the computing objects 305a-305c or the computing environments 304a-304c therein. For example, data collector 314 may be configured to pull computing object data from the computing objects 305a-305c according to scheduled time intervals.

The data collector 314 may store the collected data within the system data 350 in a structured manner, enabling efficient indexing, querying, and retrieval of information. For example, the data collector 314 may store the collected data in system data 350. By continuously collecting real-time data from the computing objects 305a-305c and computing environments 304a-304c, the data collector 314 enables the data processing system 306 to generate remedial actions based on current security conditions rather than relying on stale or outdated information, thereby improving the accuracy and relevance of generated recommendations compared to existing systems that rely on periodic batch processing or manual data collection.

In some embodiments, the collected data (or portions thereof) may be stored in the vector database 342 when the data processing system 306 generates the respective vector database 342, in accordance with one or more implementations described herein. For example, the data collector may include instructions that, when executed by the set of processors 310, cause the set of processors 310 to provide the electronic documents corresponding to the network security frameworks to the encoder 318 to generate embeddings corresponding to the electronic documents. For instance, in response to the data collector 314 collecting the electronic documents corresponding to network security frameworks, the data collector may provide the collected electronic documents (or portions thereof) to the encoder 318 to generate embeddings corresponding to the electronic documents. The encoder 318 may be the encoder of the model 316 (e.g., the first machine learning model, the large language model configured to generate remedial actions, etc.). Using the encoder 318 of the model 316 to generate embeddings for the vector database 342 is advantageous, as the model 316 may retrieve documents from the vector database 342 during inference operations. In this way, using the same encoder 318 preserves embedding space characteristics and ensures semantic consistency between the embeddings stored in the vector database 342 and the embeddings generated from input queries during retrieval operations.

In some embodiments, the electronic documents corresponding to the network security frameworks may be chunked prior to embedding generation. For example, to facilitate RAG techniques via the model 316 using the electronic documents, the data collector 314 may include instructions that, when executed by the set of processors 310, cause the set of processors 310 to invoke the encoder 318 to chunk the electronic documents into one or more chunks and generate corresponding embeddings to be stored in the vector database 342.

The encoder 318 may include instructions that, when executed by the set of processors 310, cause the set of processors 310 to apply a chunking technique to segment the electronic documents corresponding to the network security frameworks into smaller portions (e.g., document chunks) suitable for embedding generation. For example, the chunking technique may segment the electronic documents based on semantic boundaries, paragraph structures, control specifications, or fixed token lengths to produce document chunks that preserve contextual meaning while conforming to input size constraints of the encoder 318. The encoder 318 may include instructions that, when executed by the set of processors 310, cause the set of processors 310 to process each document chunk to generate a corresponding embedding, which is a dense vector representation that captures the semantic content of the document chunk in a high-dimensional vector space.

The encoder 318 may include instructions that, when executed by the set of processors 310, cause the set of processors 310 to invoke the vector database generator 324 to construct the vector database 342. For example, vector database generator 324 may be invoked, based on the encoder 318 generating embeddings corresponding to the document chunks of the electronic documents, to generate the vector database 342 using the embeddings. The vector database generator 324 may include instructions that, when executed by the set of processors 310, cause the set of processors 310 to construct the vector database 342 by indexing the embeddings using an approximate nearest neighbor (ANN) indexing structure, such as hierarchical navigable small world (HNSW) graphs, inverted file indices (IVF), or product quantization techniques, to enable efficient similarity search operations. The vector database 342 may store each embedding along with the corresponding document chunk of the electronic documents corresponding to the network security frameworks, thereby enabling retrieval of the portions of the electronic documents via retriever 320 when generating one or more recommendations or remedial actions via generator 322 of model 316.

In some embodiments, the collected data (or portions thereof) may be stored in the graph database 344 when the data processing system 306 generates the main-graph 346, in accordance with one or more implementations described herein. For example, the graph generator 328 may include instructions that, when executed by the set of processors 310, cause the set of processors 310 to generate the main-graph 346 comprising nodes corresponding to controls or requirements of the different network security frameworks (e.g., a first set of nodes) and nodes representing objects of the computing environments 304a-304c (e.g., a second set of nodes). For instance, in response to the data collector 314 collecting the electronic documents corresponding to network security frameworks and the computing object data from the computing objects 305a-305c, the graph generator 328 may generate the main-graph 346 using the collected data. The graph generator 328 may store the main-graph 346 in the graph database 344, thereby enabling the graph data retriever 330 to query the main-graph 346 during inference operations to identify relationships between network security framework controls or requirements and computing objects of the computing environments 304a-304c.

In some embodiments, the graph generator 328 may generate the first set of nodes corresponding to controls or requirements of the different network security frameworks. For example, the graph generator 328 may include instructions that, when executed by the set of processors 310, cause the set of processors 310 to apply natural language processing (NLP) techniques to extract control identifiers, requirement specifications, function categories, risk assessments, and family classifications from the electronic documents corresponding to the network security frameworks. The graph generator 328 may apply named entity recognition (NER) techniques to identify and extract specific entities such as control names, framework identifiers, compliance requirements, and security functions from the electronic documents. Each node of the first set of nodes may store an embedding (e.g., generated by the encoder 318 stored in the vector database 342) corresponding to a respective chunk of a network security framework document, a control or requirement represented by the node, a framework identifier indicating the associated network security framework (e.g., NIST CSF, SP 800-53, MITRE ATT&CK, CIS benchmarks, HIPAA, GDPR, SOC 2), a control identifier, a function category, a risk assessment, a family classification, or other network security framework information that the data collector 314 obtained.

The graph generator 328 may include instructions that, when executed by the set of processors 310, cause the set of processors 310 to generate the second set of nodes representing objects of the computing environments 304a-304c. For example, the graph generator 328 may apply NLP techniques to extract computing object information from the computing object data received by the data collector 314. Each node of the second set of nodes may store a vector embedding of the computing object generated by the encoder 318, a type classification indicating a category of the computing object (e.g., firewall, router, server, load balancer), an object identifier, state information indicating a current configuration or operational status of the computing object, a platform association indicating the computing platform on which the object operates, log information capturing activity or events associated with the computing object, or other computing object information that the data collector 314 obtained from the computing objects 305a-305c.

The graph generator 328 may include instructions that, when executed by the set of processors 310, cause the set of processors 310 to generate edges representing relationships between the first set of nodes corresponding to the network security frameworks and the second set of nodes corresponding to the computing objects. For example, the graph generator 328 may apply relationship extraction techniques to identify associations between network security framework controls or requirements and computing objects within the computing environments 304a-304c. The graph generator 328 may generate an edge between a node of the first set of nodes and a node of the second set of nodes when the graph generator 328 determines that a control or requirement of a network security framework is applicable to a computing object. The graph generator 328 may determine applicability based on corresponding identifiers between the network security framework and the computing object, such as, for example, matching a platform identifier stored in a framework data node (e.g., indicating the framework applies to cloud platforms, on-premises systems, or specific operating systems) with a platform association stored in an object node representing a computing object operating on that platform. Additionally or alternatively, the graph generator 328 may determine applicability by determining the function category or control family of a network security framework control (e.g., access control, patch management, network segmentation) and determining a correspondence to the type classification of a computing object (e.g., firewall, router, server) that performs or is subject to that function. The edges may store relationship information indicating the nature of the association between the connected nodes, such as an indication that a particular computing object is subject to a specific control or requirement of a network security framework. By generating the main-graph 346 with the first set of nodes, the second set of nodes, and the edges representing relationships therebetween, the graph generator 328 enables the data processing system 306 to preserve relationship information between syntactically dissimilar and syntactically similar elements of security frameworks and computing objects for subsequent subgraph generation and remedial action generation operations.

As described above, each node of the first set of nodes stores an embedding corresponding to a chunk of a network security framework document indicating a control, requirement, or other related information of the network security framework. Leveraging such an architecture enables data processing system 306 to leverage similarity-search techniques when identifying applicable network security framework controls or requirements in response to a user request. For example, when the system is to generate a recommendation or remedial action, the system may perform a similarity search using the embedding of the user request against the embeddings stored within the vector database to identify nodes of the first set of nodes that identify applicable network security framework controls or requirements of information in the user request. By storing embeddings within the nodes of the graph data structure, the system overcomes the strict query requirements of conventional graph data structures that require exact matches to traverse and retrieve information. The system maintains the fuzziness advantages of similarity-search techniques while also preserving the relationship information between network security framework controls or requirements and computing objects 305 of computing environments 304 through the graph structure. In this way, the system may identify conceptually similar controls or requirements that are syntactically different, thereby generating improved remedial actions that account for cross-framework relationships and compliance gaps that would otherwise be missed by systems relying solely on syntactic similarity or strict graph queries.

In some embodiments, the system may update the vector database 342 or main-graph 346 based on the data collector 314 receiving or retrieving updated information. For example, when the data collector 314 receives updated electronic documents corresponding to network security frameworks or updated computing object data from the computing objects 305a-305c, the encoder 318 may generate new embeddings for storage in the vector database 342, and the graph generator 328 may update the main-graph 346 with new nodes or modified edges. The data processing system 306 may perform such updates periodically, in response to detected changes in source data, or upon receiving push notifications from network security framework administrators. By maintaining current information in the vector database 342 and main-graph 346, the data processing system 306 can generate remedial actions based on the most recent network security framework guidance and computing environment configurations.

The graph generator 328 may include instructions that, when executed by the set of processors 310, cause the set of processors 310 to generate one or more subgraphs 348 from the main-graph 346. For example, in response to data processing system 306 receiving a user input requesting information about network security frameworks as related to objects of a computing environment, the graph generator 328 may obtain one or more embeddings corresponding to the input generated by encoder 318 to identify corresponding embeddings stored in the vector database 342. Using the corresponding embeddings, the graph data retriever 330 may query the main-graph 346 (e.g., using the embeddings identified from the vector database 342) to identify a subset of the first set of nodes corresponding to applicable controls or requirements. The graph generator 328 may generate the subgraph 348 by extracting the identified subset of nodes along with a subset of the second set of nodes linked by edges with the identified first set of nodes. The subgraph 348 preserves the edges and relationship information between the extracted nodes of the main-graph 346, enabling the graph neural network 332 to process the subgraph 348 and identify patterns, infer connections between nodes that may not be explicitly preserved in the subgraph 348, and detect gaps such as expected-but-missing edges or nodes. In some embodiments, the graph generator 328 may enhance the subgraph 348 by generating additional edges (e.g., relationships) between the nodes in a manner that is the same or similar to that described above. By generating a targeted subgraph 348, the data processing system 306 reduces the computational complexity of subsequent processing operations when generating remedial actions or recommendations over the entire main-graph 346.

The model 316 may include the encoder 318, the retriever 320, and the generator 322. As described above, the encoder 318 may include instructions that, when executed by the set of processors 310, cause the set of processors 310 to generate embeddings from input data, including embeddings of electronic documents corresponding to network security frameworks, embeddings of computing object data, and embeddings of user inputs or queries.

In some embodiments, the model 316 may be the same or similar machine learning model as the first machine learning model 204 described above. For example, model 316 may be an LLM trained to generate remedial actions for cybersecurity vulnerabilities based on network security framework information, computing object information, or other information. In some embodiments, a user may interact with model 316 via client device 302.

For example, a user may transmit a natural language query via the client device 302, such as “What NIST SP 800-53 and CIS benchmark controls apply to the firewall and router configurations in my computing environment, and what remedial actions are needed to address any compliance gaps?” In response, the encoder 318 may generate embeddings of the query and transmit them to the retriever 320. The retriever 320 may perform a similarity search against the vector database 342 to identify embeddings of electronic document portions corresponding to applicable network security frameworks. For instance, the retriever 320 may identify embeddings corresponding to NIST SP 800-53 access control requirements and CIS benchmark firewall configuration controls that are semantically similar to the query.

The retriever 320 may include instructions that, when executed by the set of processors 310, cause the set of processors 310 to retrieve relevant information from the vector database 342 based on similarity search operations. For example, the retriever 320 may receive an embedding of a user input generated by the encoder 318 and perform a similarity search against the embeddings stored in the vector database 342 to identify portions of electronic documents corresponding to network security frameworks that are semantically similar to the user input. The retriever 320 may retrieve the identified portions of electronic documents (e.g., from the vector database 342 or from system data 350) and provide the retrieved portions to the generator 322 as context for generating a response or remedial action.

In some embodiments, the retriever 320 may be communicatively coupled to the graph data retriever 330 to enable the model 316 to generate recommendations based on graph data or graph outputs from the graph neural network 332. For example, the retriever 320 may transmit the embedding of the user input to the graph data retriever 330, and the graph data retriever 330 may query the main-graph 346 using the embedding to identify relevant nodes and relationships. The graph data retriever 330 may return graph data, such as identified nodes, edges, or subgraph information, to the retriever 320. The retriever 320 may combine the retrieved portions of electronic documents from the vector database 342 with the graph data received from the graph data retriever 330 and provide the combined information to the generator 322. By communicatively coupling the retriever 320 with the graph data retriever 330, the model 316 may generate recommendations or remedial actions that account for both the semantic content of network security framework documents and the relationship information preserved in the graph data structure.

The generator 322 may include instructions that, when executed by the set of processors 310, cause the set of processors 310 to generate outputs based on the context provided by the retriever 320. For example, the generator 322 may be or include portion of a large language model configured to generate natural language responses, recommendations, or remedial actions based on the retrieved portions of electronic documents corresponding to network security frameworks, graph data, graph neural network outputs, the user input, or other information. The generator 322 may process the context provided by the retriever 320 to generate a remedial action for addressing a gap in a control or requirement of an applicable security framework with respect to one or more objects of the computing environment. The generator 322 may generate the remedial action as a natural language description, a structured recommendation, or a set of actionable steps that can be implemented within the computing environment.

The graph data retriever 330 may include instructions that, when executed by the set of processors 310, cause the set of processors 310 to obtain data from the graph database 344. For example, the graph data retriever 330 may query the main-graph 346 stored in the graph database 344 using embeddings identified from the vector database 342 to identify a subset of nodes corresponding to applicable controls or requirements of network security frameworks. As another example, the graph data retriever 330 may query the subgraph 348 stored in the graph database 344 using the embeddings for other operations. The graph data retriever 330 may traverse the edges of the main-graph 346 to identify relationships between the identified nodes and other nodes representing computing objects of the computing environments 304a-304c. The graph data retriever 330 may retrieve the identified nodes, edges, and relationship information from the graph database 344 and provide the retrieved graph data to the graph generator 328 for subgraph generation or to the retriever 320 for inclusion in the context provided to the generator 322.

In some embodiments, the graph neural network 332 may be the same or similar machine learning model as the second machine learning model 204 described above. For example, the graph neural network 332 may be trained to generate outputs related to remedial actions for cybersecurity vulnerabilities. For example, the graph neural network 332 may generate remedial actions, recommendations, indications of relationships between network security framework information and computing object information, confidence scores of generated remedial actions, or other information.

The graph neural network 332 may include instructions that, when executed by the set of processors 310, cause the set of processors 310 to process subgraphs generated by the graph generator 328 to identify patterns, infer connections, and detect gaps in controls or requirements of network security frameworks with respect to objects of a computing environment based on a subgraph. For example, the graph neural network 332 may receive a subgraph 348 as input 402 and process the nodes and edges of the subgraph 348 to generate graph outputs 404. The graph neural network 332 may analyze the edges between a first set of nodes (e.g., nodes corresponding to network security frameworks) and a second set of nodes (e.g., nodes corresponding to computing objects 305 of a computing environment 304) to identify compliance gaps, security vulnerabilities, or missing relationships between network security framework controls and computing objects. The graph outputs 404 may include candidate remedial actions, confidence scores for the candidate remedial actions, indications of expected-but-missing edges or nodes within the subgraph, indications of unexpected nodes or edges, or inferred connections between conceptually similar controls that are syntactically different across different security frameworks.

The graph neural network 332 may be trained based on one or more historical subgraphs containing nodes generated based on the different network security frameworks, enabling the graph neural network 332 to recognize patterns indicative of compliance gaps or security vulnerabilities, including patterns that indicate missing relationships 358 between controls and computing objects. In some embodiments, the graph neural network 332 may generate a plurality of candidate remedial actions and confidence scores indicating the degree of certainty that each candidate remedial action will effectively address the identified gap. The graph neural network 332 may provide the graph outputs 404 to the graph data retriever 330, which may provide the graph outputs 404 to the retriever 320 for inclusion in the context provided to the generator 322. The generator 322 may execute a large language model using the plurality of candidate remedial actions and the confidence scores to select the remedial action from among the candidate remedial actions.

In some embodiments, the validator 334 may be the same or similar machine learning model as the third machine learning model 204 described above. For example, the validator 334 may be a validation large language model trained to validate remedial actions and evaluate completeness of remedial actions generated by the model 316 or derived from the graph neural network 332.

The validator 334 may include instructions that, when executed by the set of processors 310, cause the set of processors 310 to evaluate completeness of remedial actions relative to subgraphs and acceptance criteria. For example, the validator 334 may receive a remedial action, the subgraph 348 used to generate the remedial action, and acceptance criteria information specifying completeness requirements. The validator 334 may analyze the remedial action against the nodes and edges of the subgraph 348 and the graph outputs 404 from the graph neural network 332 to determine whether the remedial action satisfies the acceptance criteria, such as coverage of applicable security framework controls, addressing of expected-but-missing edges or nodes, and inclusion of remedial actions for each computing object associated with relevant framework controls.

Responsive to determining that the remedial action is incomplete, the validator 334 may automatically trigger at least one additional iteration of the query of the graph data structure and the generation of the subgraph to obtain additional controls, requirements, or objects omitted from a prior iteration. In some embodiments, the validator 334 may generate a completeness score indicating a degree to which the remedial action addresses the nodes, edges, and relationships within the subgraph 348 relative to the acceptance criteria. The validator 334 may provide validation determinations to the generator 322, which may use the validation determinations to refine the remedial action or trigger additional processing iterations until the remedial action satisfies the acceptance criteria. By leveraging the validator 334 to remedial actions against the subgraph and acceptance criteria, the system (i) standardizes application of acceptance criteria to remedial actions, thereby forgoing subjective human-evaluator acceptances of remedial actions and (ii) comprehensively address compliance gaps across multiple network security frameworks, thereby reducing the likelihood of incomplete security assessments and improving the overall cybersecurity posture of the computing environment prior to a cybersecurity attack.

The model manager 336 may include instructions that, when executed by the set of processors 310, cause the set of processors 310 to manage the different machine learning models stored on, hosted on, or executed by the data processing system 306. For example, the model manager 336 may execute and train the model 316, the graph neural network 332, and the validator 334 to generate outputs based on data stored in the vector database 342, the graph database 344, and the system data 350. The model manager 336 may perform training operations using training data obtained from the system data 350, including network security framework information, computing object data, historical subgraphs, remedial actions, confidence scores, and validation determinations. The model manager 336 may update the configurations of the machine learning models based on error signals generated during training to improve the accuracy of generated outputs. The model manager 336 may also manage model versioning, model deployment, and model performance monitoring to ensure that the machine learning models operate effectively within the data processing system 306.

The action facilitator 338 may include instructions that, when executed by the set of processors 310, cause the set of processors 310 to implement remedial actions within the computing environments 304a-304c. For example, the action facilitator 338 may receive a remedial action (e.g., generated by the generator 322, graph neural network 332, the validator 334, or other component), and automatically implement the remedial action within the corresponding computing environment 304 or computing object 305 to reduce cybersecurity risk.

For example, the action facilitator 338 may apply natural language processing (NLP) techniques or other processing techniques to analyze the remedial action and determine how to implement the remedial action within the computing environment or computing object. For example, the action facilitator 338 may parse the remedial action to identify the type of remedial action (e.g., configuration change, security control adjustment, software update), the target computing object or computing environment to which the remedial action applies, and the specific parameters or settings to be modified. The action facilitator 338 may apply named entity recognition to extract computing object identifiers, control identifiers, configuration parameters, or other actionable elements from the remedial action. Additionally or alternatively, the action facilitator may query one or more of the graph data structures stored in graph database 344 to obtain sch information, thereby reducing computational resources expended on named entity recognition (e.g., as the graphs may already include such data). The action facilitator 338 may further apply text classification techniques to categorize the remedial action according to implementation requirements, such as determining whether the remedial action requires updating firewall rules, enabling multi-factor authentication, restricting network access permissions, applying software patches, or modifying other security configurations.

Subsequent to processing of remedial action, the action facilitator 338 may communicate with the applicable computing objects 305a-305c or computing environments 304a-304c via the communication interface 308 to obtain the applicable data required for implementation. For instance, the action facilitator 338 may retrieve a configuration profile, security policy settings, access control lists, software version information, or other data items from the target computing object or computing environment. The action facilitator 338 may modify the retrieved data according to the specifications identified in the remedial action, such as updating configuration parameters, adding or removing access permissions, or specifying software update instructions. The action facilitator 338 may then automatically transmit the modified data back to the appropriate computing object 305 or computing environment 304 to be implemented, thereby reducing cybersecurity risk within the computing environment prior to a cybersecurity attack. The action facilitator 338 may also generate implementation reports indicating the status of remedial action implementation, including successful implementations, failed implementations, and pending implementations requiring manual intervention.

The tracker 340 may include instructions that, when executed by the set of processors 310, cause the set of processors 310 to track the status of remedial actions, compliance gaps, and security posture changes within the computing environments 304a-304c. For example, the tracker 340 may maintain records of remedial actions generated by the generator 322, validation determinations generated by the validator 334, and implementation statuses generated by the action facilitator 338. The tracker 340 may monitor the computing environments 304a-304c to detect changes in compliance status, security configurations, or vulnerability states that may affect the applicability or effectiveness of previously generated remedial actions. The tracker 340 may generate alerts or notifications when new compliance gaps are detected, when remedial actions fail to be implemented, or when previously addressed vulnerabilities reappear within the computing environments 304a-304c. The tracker 340 may store tracking information in the system data 350 to enable historical analysis of security posture changes and remedial action effectiveness over time.

FIG. 3B illustrates an example graph data structure, in accordance with an implementation. For example, FIG. 3B illustrates an example of the main-graph 346 storing nodes representing network security framework information and computing objects of computing environments (e.g., a particular computing environment), in accordance with an implementation. As illustrated, the main-graph 346 can include one or more framework nodes 352a-352c (individually, framework node 352 and together, framework nodes 352) that represent controls or requirements of different network security frameworks. The main-graph 346 can also include one or more object nodes 354a-354d (individually, object node 354 and together, object nodes 354) that represent objects of computing environments. The framework nodes 352 and object nodes 354 can be connected by edges (e.g., relationships 356a-356f) that each represent associations between the respective nodes. The framework nodes 352 can each include one or more node field-value pairs for different types of characteristics or attributes of the network security framework controls or requirements represented by the framework nodes 352. The framework nodes 352 can include one or more attributes such as, for example, a vector embedding corresponding to (e.g., generated from) a chunk of a network security framework document, a framework identifier indicating the associated network security framework (e.g., NIST CSF, SP 800-53, MITRE ATT&CK, CIS benchmarks, HIPAA, GDPR, SOC 2), a control identifier (e.g., AC-1, AC-2, SC-7), a function category (e.g., Identify, Protect, Detect, Respond, Recover), a risk assessment indicating severity or priority levels, a family classification (e.g., Access Control, System and Communications Protection, Incident Response), a requirement specification describing the control objective, implementation guidance, assessment procedures, related controls, or other information extracted from network security framework documents.

The object nodes 354 can each include one or more node field-value pairs for different types of characteristics or attributes of the computing objects represented by the object nodes 354. The object nodes 354 can include one or more attributes such as, for example, a vector embedding of the computing object (or alternatively, a vector embedding of the respective object node 354 itself), a type classification indicating a category of the computing object (e.g., firewall, router, server, load balancer, intrusion detection system, endpoint device, virtual machine, database), an object identifier (e.g., a particular type, manufacturer, model, or other granular information of the computing object), state information indicating a current configuration or operational status of the computing object, a platform association indicating the computing platform on which the object operates (e.g., cloud platform, on-premises system, specific operating system), log information capturing activity or events associated with the computing object, network segment information, software version information, patch status, security policy configurations, or other computing object information.

The edges (e.g., relationships 356a-356f) of the main-graph 346 can be or include data structures (e.g., edge data structures). For example, the edge data structures can each include one or more edge field-value pairs for different types of characteristics or attributes of the relationships represented by the edges. The edges can include one or more attributes such as, for example, a relationship type indicating the nature of the association between connected nodes (e.g., “applies to,” “is subject to,” “implements,” “mitigates”), an applicability indicator specifying whether a control or requirement applies to a particular computing object, a compliance status indicating whether the computing object satisfies the associated control or requirement, a timestamp indicating when the relationship was established or last updated, a confidence score indicating the strength or certainty of the relationship, cross-framework mapping information indicating conceptually similar controls across different security frameworks, or other relationship information. The edge data structures can each include identifiers of the nodes that the edges are connecting, in some cases forming the edge in a structured manner that enables traversal between framework nodes 352 and object nodes 354.

In some embodiments, the main-graph 346 may be a non-computing-environment-specific and non-network-security-framework-specific graph data structure that includes all available information that the data collector 314 has collected and continues to collect over time. For example, the main-graph 346 may aggregate network security framework information from multiple different frameworks (e.g., NIST CSF, SP 800-53, MITRE ATT&CK, CIS benchmarks, HIPAA, GDPR, SOC 2), computing object data from all computing environments 304a-304c and computing objects 305a-305c, and relationship information between the framework nodes 352 and object nodes 354. As the data collector 314 receives updated electronic documents corresponding to network security frameworks or updated computing object data, the graph generator 328 may update the main-graph 346 with new nodes, modified node attributes, or new edges representing newly identified relationships. By maintaining a comprehensive main-graph 346 that encompasses all collected information, the data processing system 306 can generate targeted subgraphs that are specific to particular user queries, computing environments, or network security frameworks without requiring separate graph construction for each query. This approach reduces computational overhead during inference operations, as the system can extract relevant portions of the pre-constructed main-graph 346 rather than building graph structures from raw data for each request. Additionally, the comprehensive nature of the main-graph 346 enables the identification of cross-framework relationships and compliance gaps that span multiple network security frameworks, thereby providing more complete security assessments than systems that analyze individual frameworks in isolation.

The data processing system 306 can generate the graph data structure 346 for a particular computing environment. For example, the data processing system 306 can receive or ingest data or electronic records describing the computing environment of a computing system. The data processing system 306 can do so automatically responsive to being plugged into the computing system or responsive to receiving a request from the computing system. The data processing system can receive or ingest the data or electronic records in the request or after receiving the data or electronic records in one or more messages. In some cases, the data processing system can retrieve (e.g., automatically retrieve) the data or records from one or more data repositories in the computing system, such as in response to being connected with the computing system (e.g., with a computing device of the computing system).

The data processing system 306 can process the ingested data or electronic records to generate the main graph 346. For example, the data processing system 306 can generate the nodes 352 and 354 and the edges describing the relationships between the nodes 352 and 354 using the data or electronic records, as described herein. Each of the nodes can include a vector or embedding representing or describing the data from which the nodes were generated. The data processing system 306 can generate a vector database containing the data or electronic records. The data processing system 306 can generate the vector database to include the same embeddings as the main graph 346 as associations with the same corresponding data or electronic records.

FIG. 3C illustrates an example subgraph data structure of the example graph data structure of FIG. 3B, in accordance with an implementation. For example, FIG. 3B illustrates an example of the subgraph 348 representing a targeted subset of the main-graph 346 that is generated based on a user query or input. As illustrated in FIG. 3C, the subgraph 348 can include a subset of the framework nodes 352 and a subset of the object nodes 354 from the main-graph 346, along with the edges connecting the included nodes. For example, the subgraph 348 can include framework nodes 352a and 352b representing controls or requirements of one or more network security frameworks applicable to a particular computing environment, and object nodes 354a and 354b representing objects of the computing environment that are relevant to the user query.

The graph generator 328 may generate the subgraph 348 from the main-graph 346 based on embeddings identified from the vector database 342. For example, in response to receiving an input requesting information about network security frameworks as related to objects of a computing environment, the encoder 318 may generate an embedding of the input. The retriever 320 may perform a similarity search against the vector database 342 using the embedding of the input to identify one or more embeddings of portions of electronic documents corresponding to network security frameworks applicable to the computing environment. The graph data retriever 330 may query the main-graph 346 using the identified embeddings to identify a subset of the framework nodes 352 that correspond to controls or requirements of the network security frameworks applicable to the computing environment. The graph generator 328 may then generate the subgraph 348 from the identified subset of framework nodes 352 and a subset of object nodes 354 linked by edges with the identified framework nodes 352.

The subgraph 348 preserves the edges and relationship information between the extracted nodes. As illustrated, the subgraph 348 includes relationships 356a, 356b, and 356c connecting the framework nodes 352a and 352b with the object nodes 354a and 354b.

The subgraph 348 may also include a missing relationship 358, depicted as a dashed line, indicating an expected-but-missing edge between nodes that the graph neural network 332 may identify during processing. For example, the missing relationship 358 may indicate a gap in a control or requirement of an applicable security framework with respect to a computing object, where the graph neural network 332 infers that a relationship should exist based on patterns learned from historical subgraphs but the relationship is not explicitly present in the subgraph 348. In response to identifying the expected-but-missing edge, the graph generator 328 may update the subgraph 348 to include the edge.

Similarly, the graph neural network 332 may identify an expected-but-missing node within the subgraph 348, indicating that a framework node 352 or object node 354 should be present based on patterns learned from historical subgraphs but is not explicitly included in the subgraph 348. In response to identifying the expected-but-missing node, the graph generator 328 may update the subgraph 348 to include the node along with any associated edges connecting the node to existing nodes within the subgraph 348.

Additionally, the graph neural network 332 may identify an unexpected node or edge within the subgraph 348, indicating that a node or relationship is present that should not exist based on patterns learned from historical subgraphs. In response to identifying an unexpected node or edge, the graph generator 328 may update the subgraph 348 to remove the unexpected node or edge, or flag the unexpected node or edge for further analysis.

By updating the subgraph 348 based on expected-but-missing edges, expected-but-missing nodes, and unexpected nodes or edges identified by the graph neural network 332, the data processing system 306 can generate more accurate and complete subgraphs that reflect the true relationships between network security framework controls or requirements and computing objects, thereby improving the quality of remedial actions generated based on the subgraph 348 and reducing the likelihood of incomplete security assessments. Furthermore, by generating the subgraph 348 as a targeted extraction from the main-graph 346, the data processing system 306 reduces the computational complexity of subsequent processing operations (e.g., graph neural network processing, etc.) while preserving the relationship information necessary for generating remedial actions.

### D. Systems and Methods for Facilitating Remedial Actions to Cybersecurity Vulnerabilities

Existing systems for cybersecurity risk assessment and compliance management face significant technical limitations when attempting to retrieve relevant context from security framework documentation to generate remedial actions. For example, retrieval-Augmented Generation (RAG) models rely solely on vector database similarity search techniques that are constrained by their dependence on syntactic similarity between embeddings of user queries and embeddings of chunked documents stored in the vector database. This technical limitation is particularly problematic in the cybersecurity domain, where different network security frameworks such as NIST CSF, SP 800-53, MITRE ATT&CK, CIS benchmarks, HIPAA, and GDPR describe conceptually identical controls or requirements using different terminology and syntax. For example, one security framework may describe access control requirements for cloud platforms using terminology specific to a particular vendor (e.g., Azure), while another framework may describe functionally equivalent requirements using different platform-specific terminology. When a user queries the model about security controls applicable to their computing environment, the vector database similarity search may fail to retrieve relevant context from frameworks that describe conceptually similar controls using syntactically different language, resulting in incomplete security assessments and missed compliance gaps.

Existing systems that attempt to overcome the limitations of vector database similarity search by employing graph data structures face their own technical challenges. Graph data structures may preserve relationship information between data elements, enabling the identification of connections between security framework controls and computing environment objects. However, graph data structures require specific queries with precise parameters to traverse and retrieve information, unlike the flexible similarity-based searching provided by vector databases. The edges and relationships in graph databases have precise labels and particular attributes for nodes and edges, requiring exact matches to traverse the graph structure. As a result, graph data structures lack the flexibility to handle natural language queries that do not exactly match stored relationship structures, thereby preventing users from leveraging the preserved relationship information when their queries do not conform to the rigid query requirements of the graph database. This architectural mismatch between the flexibility of user queries and the strict traversal requirements of graph data structures creates a technical barrier that prevents existing systems from effectively combining the semantic matching capabilities of vector embeddings with the relationship preservation of graph data structures.

To overcome these technical deficiencies, the methods and systems described herein facilitate remedial actions to cybersecurity vulnerabilities by combining vector database similarity search with graph data structure querying to generate targeted remedial actions that account for conceptual similarity rather than relying solely on syntactic similarity. For example, the system addresses the fundamental limitations of existing RAG systems by generating a graph data structure comprising a first set of nodes corresponding to controls or requirements of different network security frameworks, where each node stores an embedding from a vector database corresponding to a control or requirement represented by the node. By storing embeddings within the nodes of the graph data structure, the system maintains the flexibility of similarity-based searching while preserving relationship information between network security framework controls and computing environment objects through the graph structure. This architectural approach enables the system to query the graph data structure using embeddings identified from the vector database to identify a subset of nodes that correspond to controls or requirements of network security frameworks applicable to a computing environment, thereby overcoming the rigid query requirements of conventional graph data structures that require exact matches to traverse and retrieve information.

To do so, the system identifies one or more electronic documents each corresponding to a different network security framework providing a structured approach for managing and reducing cybersecurity risk. The system generates a vector database comprising embeddings converted from each of the electronic documents and generates a graph data structure comprising the first set of nodes corresponding to controls or requirements of the different network security frameworks and a second set of nodes representing objects of a computing environment. In response to receiving an input requesting information about the different network security frameworks as related to the objects of the computing environment, the system generates an embedding of the input and identifies one or more embeddings of portions of electronic documents corresponding to network security frameworks applicable to the computing environment from the vector database based on the embedding of the input. The system then queries the graph data structure using the identified embeddings to identify a subset of the first set of nodes that correspond to controls or requirements of the network security frameworks applicable to the computing environment. By leveraging the embeddings to query the graph data structure, the system identifies conceptually similar controls or requirements that are syntactically different across different security frameworks, thereby reducing the likelihood of incomplete security assessments that plague existing systems relying solely on syntactic similarity. The system generates a subgraph from the identified subset of nodes and a subset of the second set of nodes linked by edges with the first set of nodes, reducing computational complexity by extracting only the relevant portions of the graph data structure rather than processing the entire graph during subsequent operations.

Such a technical approach overcomes the critical gap in existing systems that fail to combine the semantic matching capabilities of vector embeddings with the relationship preservation of graph data structures. By generating the subgraph as a targeted extraction from a main-graph based on similarity-identified embeddings, the system reduces computational resource requirements by processing only the relevant subset of nodes and edges rather than the entire graph data structure, while simultaneously improving accuracy by preserving the relationship information necessary for identifying compliance gaps across multiple network security frameworks. The system may then generate, using the edges between the first and second sets of nodes of the subgraph, a remedial action for addressing a gap in a control or requirement of an applicable security framework with respect to one or more objects of the computing environment. Using the generated remedial action, the system may automatically implement the remedial action within the applicable computing environment in real-time (or near-real time), thereby reducing cybersecurity risk within the computing environment.

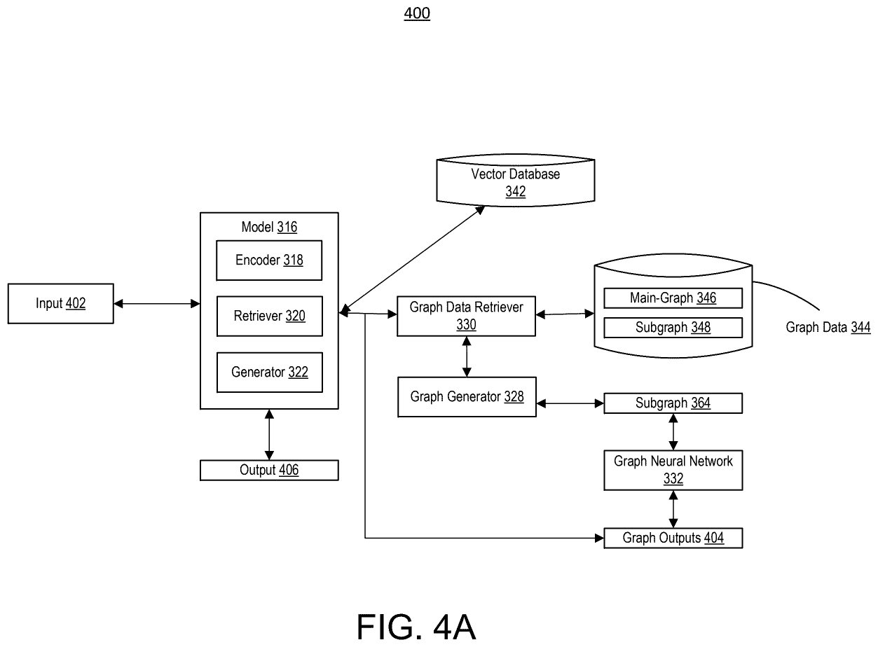

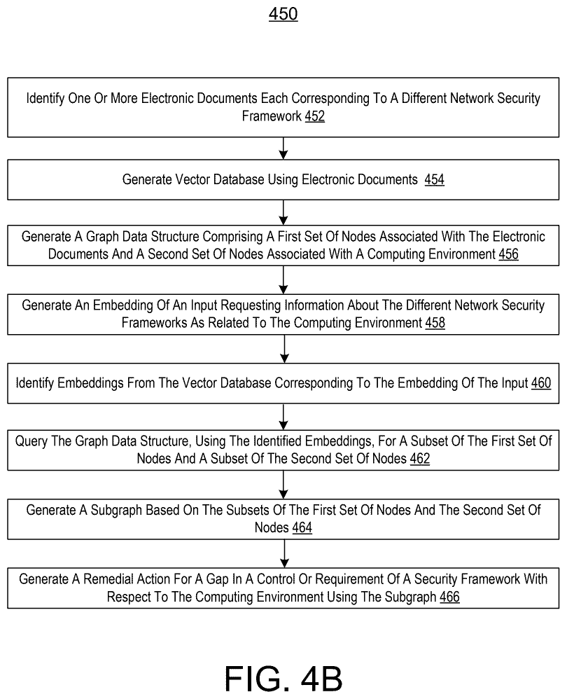

FIG. 4A is an illustration of an example subsystem 400 to generate remedial actions for cybersecurity vulnerabilities, in accordance with an implementation. For example, subsystem 400 may include one or more components of FIG. 3A for generating one or more remedial actions for cybersecurity vulnerabilities. The subsystem 400 may receive an input 402 requesting information about network security frameworks as related to objects of a computing environment. The client device 302 may present a user interface (e.g., a chatbot interface, graphical user interface, or other interface) for interacting with one or more components of subsystem 400.

The user may provide input 402 via the user interface requesting information about network security frameworks as related to objects of a computing environment. For example, the input 402 may be a natural language query from a user via client device 302 indicating “What NIST SP 800-53 and CIS benchmark controls apply to the firewall configurations in my computing environment, and what remedial actions are needed to address any compliance gaps?” As another example, the input 402 may be a natural language query from a user via client device 302 indicating “What security vulnerabilities exist with respect to my firewall when considering NIST SP 800-53?” As yet another example, the input 402 may be a statement indicating “Tell me about the security state of my server with respect to CIS benchmarks and HIPAA requirements.” The input 402 is provided to the model 316, which processes the input 402 via the encoder 318 to generate an embedding of the input 402.

The retriever 320 of the model 316 may perform a similarity search against the vector database 342 using the embedding of the input 402 to identify one or more embeddings of portions of electronic documents corresponding to network security frameworks applicable to the computing environment. For instance, the retriever 320 may identify embeddings corresponding to NIST SP 800-53 access control requirements and CIS benchmark firewall configuration controls that are semantically similar to the input 402. The retriever 320 may retrieve the portions of the electronic documents corresponding to the identified embeddings from the vector database 342 or from the system data 350.

In some embodiments, the retriever 320 may retrieve the portions of the electronic documents corresponding to the identified embeddings from the vector database 342, where the document chunks are stored in association with their respective embeddings, or from the system data 350, where the original electronic documents are maintained. The retrieved portions of the electronic documents may include control specifications, requirement descriptions, implementation guidance, assessment procedures, and cross-references to related controls that provide contextual information for generating the output 406. In some embodiments, the retrieved portions of the electronic documents may be used to generate the remedial action (e.g., output 406). For example, subsequent to the retriever 320 retrieving the portions of the electronic documents (e.g., that correspond to the one or more embeddings based on the embedding of the input 402), retriever 320 may provide the portions of the electronic documents to the generator 322 to generate a remedial action. In some embodiments, the generator 322 may generate the remedial action based on the input 402 and the portions of the electronic documents. However, as will be explained, in other embodiments, the generator 322 may generate the remedial action (e.g., output 406) based on the input 402, the portions of the electronic documents, and the graph outputs 404.

In some embodiments, the retriever 320 may transmit the identified embeddings of the portions of the electronic documents to the graph data retriever 330, which queries the main-graph 346 stored in the graph database 344 using the identified embeddings. For example, graph data retriever 330 may query, traverse, or otherwise search the main-graph 346 to identify a subset of nodes corresponding to controls or requirements of network security frameworks associated with the computing environment. For example, as the main-graph may store framework nodes 352a-352c, and such framework nodes 352a-352c may indicate controls or requirements of network security frameworks, the system may identify a subset of these nodes that are associated with the network security framework(s) being employed within a computing environment 304 indicated in input 402.

To identify network security frameworks applicable to the computing environment, the graph data retriever 330 may accept parameters extracted from the input 402, such as a computing environment identifier, an organization identifier, or platform-specific indicators parsed from the natural language query using named entity recognition or other natural language processing techniques. The graph data retriever 330 may use these extracted parameters in conjunction with the identified embeddings to filter the main-graph 346 and identify nodes corresponding to network security frameworks that are applicable to the specific computing environment referenced in the input 402.

The graph data retriever 330 may determine whether an existing subgraph 348 stored in the graph database 344 corresponds to the input 402. For example, the graph data retriever 330 may compare the identified embeddings and the extracted computing environment identifier with embeddings and identifiers associated with previously generated subgraphs 348 to determine whether a stored subgraph 348 sufficiently addresses the input 402. If the graph data retriever 330 determines that an existing subgraph 348 corresponds to the input 402, the graph data retriever 330 may retrieve the existing subgraph 348 from the graph database 344, thereby conserving computational resources that would otherwise be expended on generating a new subgraph.

If the graph data retriever 330 determines that no existing subgraph 348 corresponds to the input 402, the graph generator 328 may generate a subgraph 364 based on the input 402. For example, subgraph 364 may be generated in response to the specific input 402 by extracting the identified subset of framework nodes 352 from the main-graph 346. The graph generator 328 may then determine which computing object nodes of a computing environment are associated with the identified subset of framework nodes that are linked by edges. For example, the object nodes 354 stored in the main-graph 346 may be linked by edges with the identified subset of framework nodes 352. The graph generator may identify the object nodes 354 representing objects of the computing environment by traversing the relationships 356 stored in the main-graph 346. For each framework node 352 in the identified subset, the graph generator 328 may identify all object nodes 354 that share an edge with the framework node 352, thereby identifying computing objects that are subject to or associated with the controls or requirements represented by identified subset of framework nodes 352 for the computing environment.

In some embodiments, the graph generator 328 may filter the object nodes 354 based on particular computing objects requested in the input 402. For example, if the input 402 specifies a particular computing object type (e.g., firewall, router, server), the graph generator 328 may apply a filter to include only object nodes 354 having a type classification attribute that matches the specified computing object type. The graph generator 328 may extract computing object identifiers, type classifications, or platform associations from the input 402 using named entity recognition or other natural language processing techniques and use the extracted parameters to filter the object nodes 354 linked by edges with the identified framework nodes 352. By filtering the object nodes 354 based on the parameters extracted from the input 402, the graph generator 328 generates a targeted subgraph 364 that includes only the computing objects relevant to the user query, thereby reducing computational complexity during subsequent graph neural network processing.

In other embodiments, however, the graph generator 328 may identify object nodes 354 that are not explicitly identified in the input 402 but are related to other object nodes 354 or the identified subset of framework nodes 352 that are indicated in the input 402. For example, the graph generator 328 may traverse the edges of the main-graph 346 to identify object nodes 354 that share edges with the same framework nodes 352 as the object nodes 354 explicitly identified in the input 402, thereby identifying computing objects that are subject to the same controls or requirements. Additionally, the graph generator 328 may identify object nodes 354 that are connected to the explicitly identified object nodes 354 through intermediate framework nodes 352, enabling the discovery of related computing objects that may be affected by the same compliance gaps or security vulnerabilities. By including object nodes 354 that are related to but not explicitly identified in the input 402, the graph generator 328 generates a more comprehensive subgraph 364 that accounts for dependencies and relationships between computing objects within the computing environment. The graph generator 328 may store the generated subgraph 364 in the graph database 344 for potential reuse in response to future inputs that correspond to the subgraph 364.

The graph neural network 332 then receives the subgraph 364 (or the retrieved subgraph 348) as input and processes the nodes and edges of the subgraph to generate graph outputs 404. For example, the graph neural network 332 may generate, using the edges between the first and second sets of nodes (e.g., the framework nodes 352 and the object nodes 354) of the subgraph, a remedial action (e.g., graph outputs 404) for addressing a gap in a control or requirement of an applicable security framework with respect to one or more objects of the computing environment. In such embodiments, the graph outputs 404 may be or include the remedial action generated by the graph neural network 332.

In some embodiments, the graph outputs 404 may be provided back to the retriever 320 or retrieved from the graph data retriever 330 by the retriever 320. For example, the graph data retriever 330 may receive the graph outputs 404 from the graph neural network 332 and provide the graph outputs 404 to the retriever 320. The retriever 320 may combine the retrieved portions of electronic documents from the vector database 342 with the graph outputs 404 received from the graph data retriever 330 and provide the combined information to the generator 322 as context for generating a remedial action. The generator 322 may process the input 402, the retrieved portions of electronic documents, and the graph outputs 404 to generate the remedial action (e.g., output 406). In this manner, the generator 322 may generate the remedial action based further on the retrieved portions of the electronic documents and the graph outputs 404, enabling the generation of context-aware remedial actions that incorporate both the semantic content of network security framework documents and the relationship information derived from the graph neural network 332 processing of the subgraph.

In some embodiments, the remedial action may be generated by generating an indication of an expected-but-missing edge between nodes of the subgraph, an indication of an expected-but-missing node within the subgraph, or an indication of an unexpected node or edge within the subgraph. For example, the graph neural network 332 may analyze the subgraph 364 and identify that an edge should exist between a firewall object node and a NIST SP 800-53 access control requirement node based on patterns learned from historical subgraphs, but the edge is not present in the subgraph 364. The graph outputs 404 may include an indication of this expected-but-missing edge, and the generator 322 may generate a remedial action specifying that the firewall configuration should be updated to implement the access control requirement represented by the framework node. Similarly, the graph neural network 332 may identify an expected-but-missing node within the subgraph 364, indicating that a framework node or object node should be present based on the relationships and patterns within the subgraph but is not explicitly included. The graph neural network 332 may also identify an unexpected node or edge within the subgraph 364, indicating that a node or relationship is present that should not exist based on patterns learned from historical subgraphs, which may suggest a misconfiguration or security anomaly requiring remediation.

In some embodiments, the remedial action may be generated by executing the graph neural network 332 using the subgraph as input. The graph neural network 332 may be trained based on one or more historical subgraphs containing nodes generated based on the different network security frameworks. For example, the graph neural network 332 may be trained during a training routine using historical subgraphs that include framework nodes 352 corresponding to controls or requirements from NIST CSF, SP 800-53, MITRE ATT&CK, CIS benchmarks, HIPAA, GDPR, SOC 2, or other network security frameworks, along with object nodes 354 representing computing objects from various computing environments. The training data may include labeled examples of compliance gaps, expected relationships between framework controls and computing objects, and remedial actions that were successfully implemented to address identified gaps. By training the graph neural network 332 on historical subgraphs, the graph neural network 332 learns to recognize patterns indicative of compliance gaps or security vulnerabilities, including patterns that indicate missing relationships between controls and computing objects, and generates remedial actions based on the learned patterns.

In some embodiments, the generator 322 may generate the remedial action by processing an output of the graph neural network 332 generated based on the input 402 to generate the remedial action (e.g., output 406). For example, the graph neural network 332 may process the subgraph 364 to generate graph outputs 404 that include candidate remedial actions, confidence scores, indications of expected-but-missing edges or nodes, or other information derived from the graph analysis. The generator 322, which may be or include a large language model, may receive the graph outputs 404 and process the graph outputs 404 along with the input 402 and the retrieved portions of electronic documents to generate a refined remedial action. The large language model may enhance the candidate remedial actions from the graph outputs 404 with additional context from the retrieved portions of electronic documents, such as implementation guidance, assessment procedures, or related controls specified in the network security framework documentation, to generate a comprehensive remedial action that addresses the identified compliance gap.

In some embodiments, the subsystem 400 may generate the remedial action by iteratively repeating the query of the graph data structure, the generation of the subgraph, the execution of the large language model (e.g., model 316), and the execution of the graph neural network until determining the remedial action satisfies an acceptance criteria. The acceptance criteria may include completeness requirements such as coverage of applicable security framework controls identified in the subgraph, addressing of expected-but-missing edges or nodes identified by the graph neural network 332, and inclusion of remedial actions for each computing object associated with relevant framework controls. For example, the data processing system 306 may perform an initial iteration where the graph data retriever 330 queries the main-graph 346, the graph generator 328 generates the subgraph 364, the graph neural network 332 processes the subgraph 364 to generate graph outputs 404, and the generator 322 generates a candidate remedial action based on the graph outputs 404. The data processing system 306 may then evaluate the candidate remedial action against the acceptance criteria to determine whether the remedial action is complete and addresses all applicable controls, requirements, and computing objects identified in the subgraph. For instance, the acceptance criteria may be satisfied when the candidate remedial action addresses each framework node 352 in the subgraph 364, provides remediation steps for each object node 354 linked by edges to the framework nodes, and resolves any missing relationships 358 identified by the graph neural network 332. If the candidate remedial action does not satisfy the acceptance criteria, the data processing system 306 may perform additional iterations, refining the query of the graph data structure, expanding the subgraph, and regenerating the remedial action until the acceptance criteria are satisfied.

In some embodiments, the generator 322 may be executed to generate the remedial action by executing, as part of determining whether the remedial action satisfies the acceptance criteria, a validation large language model configured to evaluate completeness of the remedial action relative to the subgraph to determine whether the remedial action satisfies the acceptance criteria. For example, the validator 334 may be or include the validation large language model that receives the candidate remedial action generated by the generator 322, the subgraph 364 used to generate the remedial action, and the acceptance criteria information. The validator 334 may analyze the candidate remedial action against the nodes and edges of the subgraph 364 and the graph outputs 404 from the graph neural network 332 to determine whether the remedial action satisfies the acceptance criteria, such as coverage of applicable security framework controls, addressing of expected-but-missing edges or nodes, and inclusion of remedial actions for each computing object associated with relevant framework controls. Responsive to the validation large language model determining that the remedial action is incomplete based on the determination as to whether the remedial action satisfies the acceptance criteria, the data processing system 306 may automatically trigger at least one additional iteration of the query of the graph data structure and the generation of the subgraph to obtain additional controls, requirements, or objects omitted from a prior iteration. For example, if the validator 334 determines that the candidate remedial action does not address a particular NIST SP 800-53 control that is present in the subgraph 364, the data processing system 306 may trigger an additional iteration where the graph data retriever 330 queries the main-graph 346 to obtain additional information related to the omitted control, the graph generator 328 expands the subgraph 364 to include additional relevant nodes and edges, and the generator 322 regenerates the remedial action to address the previously omitted control.

In some embodiments, the generator 322 may generate the remedial action by executing the graph neural network 332 using the subgraph as input to generate a plurality of candidate remedial actions and confidence scores for the plurality of candidate remedial actions. For example, the graph neural network 332 may analyze the subgraph 364 and identify multiple compliance gaps or security vulnerabilities, generating a candidate remedial action for each identified gap along with a confidence score indicating the degree of certainty that the candidate remedial action will effectively address the identified gap. The confidence scores may be based on patterns learned from historical subgraphs, the strength of relationships between nodes in the subgraph, or other factors derived from the graph neural network 332 processing. The generator 322 may then select, using the plurality of candidate remedial actions and the confidence scores for the plurality of candidate remedial actions, the remedial action. For example, the generator 322 may evaluate the candidate remedial actions based on the confidence scores, the retrieved portions of electronic documents, and the input 402 to select the candidate remedial action with the highest confidence score or to select a combination of candidate remedial actions that collectively address the identified compliance gaps. The generator 322 may refine the selected candidate remedial action with additional context from the retrieved portions of electronic documents to generate the final remedial action for inclusion in the output 406.

In some embodiments, the generated remedial action (e.g., part of graph outputs 404, output 406, etc.) may be transmitted to the client device 302 via the communication interface 308 for display on the user interface presented at the client device. For example, the data processing subsystem may transmit the generated remedial actions to the client device 302, and client device 302 may present an indication of the remedial action on the user interface. The indication may be or include a natural language description of the remedial action, a structured list of actionable steps, a visual representation of the identified compliance gap, a priority ranking, a confidence score associated with the remedial action, a reference to the applicable network security framework control or requirement, an identification of the affected computing object, or a combination thereof. By doing so, the user may be made aware of recommended remedial actions for addressing identified gaps or other security vulnerabilities within a computing environment.

In some embodiments, the remedial action may be automatically implemented within the computing environment to reduce cybersecurity risk. For example, the action facilitator 338 may receive the generated remedial action from the generator 322 or the graph neural network 332 and automatically implement the remedial action within the applicable computing environment 304 or computing object 305 without requiring manual intervention by a user. The action facilitator 338 may communicate with the computing objects 305a-305c via the communication interface 308 to apply the remedial action directly to the affected components of the computing environment. The automatic implementation may include initiating at least one configuration change, security control adjustment, or software update to a component of the computing environment.

For instance, the action facilitator 338 may automatically initiate a configuration change by modifying firewall rules on a firewall computing object 305a to implement an access control requirement identified as missing in the subgraph 364, such as restricting network traffic according to a NIST SP 800-53 access control requirement. As another example, the action facilitator 338 may automatically initiate a security control adjustment by enabling multi-factor authentication on an authentication server computing object in response to a CIS benchmark control identified as missing in the graph neural network 332 analysis. As a further example, the action facilitator 338 may automatically initiate a software update by deploying a security patch to a server computing object 305b to address a vulnerability identified through the analysis of the subgraph 364 against MITRE ATT&CK technique descriptions.

The action facilitator 338 may also automatically initiate configuration changes such as updating access control lists on routers, modifying encryption settings on database servers, adjusting network segmentation configurations on switches, or updating certificate configurations on web servers. By automatically implementing the remedial action within the computing environment through configuration changes, security control adjustments, or software updates, the data processing system 306 reduces the time between identification of a compliance gap or security vulnerability and the implementation of corrective measures, thereby improving the overall cybersecurity posture of the computing environment prior to a potential cybersecurity attack and ensuring that the computing environment maintains alignment with applicable network security framework requirements.

FIG. 4B illustrates an example flowchart of a process for facilitating remedial actions to cybersecurity vulnerabilities, in accordance with an implementation. A data processing system (e.g., the data processing system 306, shown and described with reference to FIG. 3A and/or subsystem 400, shown and described with reference to FIG. 4A) can perform the process 450 to generate and implement remedial actions to cybersecurity vulnerabilities to reduce cybersecurity risk of one or more computing environments. The process 450 can include any number of operations or additional operations and the operations may be performed in any order.

At operation 452, the data processing system can identify one or more electronic documents each corresponding to a different network security framework. The electronic documents may provide a structured approach for managing and reducing cybersecurity risk.

At operation 454, the data processing system can generate a vector database using electronic documents. The data processing system can generate a vector database including embeddings converted from each of the one or more electronic documents. For example, the data processing system can chunk the electronic documents and generate corresponding embeddings for storage in the vector database.

At operation 456, the data processing system can generate a graph data structure including a first set of nodes associated with the electronic documents and a second set of nodes associated with a computing environment. For example, the data processing system can generate a graph data structure including a first set of nodes corresponding to controls or requirements of the different network security frameworks. Each of the first set of nodes may store an embedding from the vector database corresponding to a control or requirement represented by the node. The graph data structure may also include a second set of nodes representing objects of a computing environment.

At operation 458, the data processing system can generate an embedding of an input requesting information about the different network security frameworks as related to the computing environment. For example, the input requesting information about the different network security frameworks may be related to objects of the computing environment. The data processing system may receive the input as a natural language query from a user interface presented on a client device.

At operation 460, the data processing system can identify embeddings from the vector database corresponding to the embedding of the input. For example, the data processing system can identify one or more embeddings of portions of electronic documents corresponding to network security frameworks applicable to the computing environment from the vector database based on the embedding of the input.

At operation 462, the data processing system can query the graph data structure, using the identified embeddings, for a subset of the first set of nodes and a subset of the second set of nodes. For example, the data processing system can query the graph data structure using the one or more embeddings to identify a subset of the first set of nodes that correspond to controls or requirements of the network security frameworks applicable to the computing environment.

At step 464, the data processing system can generate a subgraph based on the subsets of the first set of nodes and the second set of nodes. For example, the data processing system can generate a subgraph based on the identified subset of the first set of nodes that correspond to the controls or requirements of the security frameworks applicable to the computing environment and a subset of the second set of nodes linked by edges with the first set of nodes representing objects of the computing environment.

At operation 466, the data processing system can generate a remedial action for a gap in a control or requirement of a security framework with respect to the computing environment using the subgraph. For example, the data processing system can generate, using the edges between the first and second sets of nodes of the subgraph, a remedial action for addressing a gap in a control or requirement of an applicable security framework with respect to one or more objects of the computing environment. The data processing system can automatically implement the remedial action within the computing environment to reduce cybersecurity risk within the computing environment. For example, the data processing system can automatically initiate at least one configuration change, security control adjustment, or software update to a component of the computing environment to automatically implement the remedial action. The data processing system may present an indication of the remedial action at a client device on the user interface.

To generate the remedial action, the data processing system may generate the remedial action generate the remedial action for addressing the gap in the control or requirement of the applicable security framework with respect to one or more objects of the computing environment by generating an indication of an expected-but-missing edge between nodes of the subgraph, an indication of an expected-but-missing node within the subgraph, or an indication of an unexpected node or edge within the subgraph. As another example, the data processing system may generate the remedial action by retrieving the portions of the electronic documents corresponding to the one or more embeddings based on the embedding of the input. Data processing system can then generate the remedial action based further on the retrieved portions of the electronic documents.

As another example, the data processing system can generate the remedial action by executing a graph neural network using the subgraph as input. The graph neural network may be trained based on one or more historical subgraphs containing nodes generated based on the different network security frameworks. The data processing system can then generate the remedial action further based on executing a large language model using an output of the graph neural network generated based on the input to generate the remedial action. The data processing system can iteratively repeat the query of the graph data structure, the generation of the subgraph, the execution of the large language model, and the execution of the graph neural network until determining the remedial action satisfies an acceptance criteria. Data processing system can then execute the large language model to generate the remedial action by executing, as part of determining whether the remedial action satisfies the acceptance criteria, a validation large language model configured to evaluate completeness of the remedial action relative to the subgraph to determine whether the remedial action satisfies the acceptance criteria. Response to the validation large language model determining that the remedial action is incomplete based on the determination as to whether the remedial action satisfies the acceptance criteria, automatically triggering at least one additional iteration of the query of the graph data structure and the generation of the subgraph to obtain additional controls, requirements, or objects omitted from a prior iteration.

As yet another example, the data processing system can generate the remedial action by executing a graph neural network using the subgraph as input to generate a plurality of candidate remedial actions and confidence scores for the plurality of candidate remedial actions. Data processing system can then execute a large language model using the plurality of candidate remedial actions and the confidence scores for the plurality of candidate remedial actions to select the remedial action.

In an example, a data processing system can be deployed within a computing environment of a software-as-a-service (SaaS) platform company that operates a multi-tenant cloud application, containerized backend services, managed databases, and a cloud-based identity provider. The data processing system can store, in memory, electronic documents corresponding to multiple security frameworks, including a national cybersecurity framework, an international information security management standard, and a cloud security controls framework. The data processing system can generate embeddings from the electronic documents and can populate a vector database with the embeddings. The data processing system can further generate a graph data structure that includes a first set of nodes representing individual security framework controls such as identity and access management, logging and monitoring, tenant isolation, and configuration management requirements, and a second set of nodes representing computing environment objects such as Kubernetes clusters, production databases, API gateways, and identity provider tenants, with each control node storing a corresponding embedding. The data processing system can include embeddings generated for documents or portions of documents in the nodes representing the corresponding documents or portions of documents.

The data processing system can receive an input requesting information about how the security frameworks apply to the SaaS platform, including receiving a natural-language query such as “Which security framework controls apply to our production Kubernetes cluster?” from a client device. The data processing system can generate an embedding of the input and can identify, from the vector database, embeddings corresponding to portions of the security framework documents related to workload isolation, role-based access control, service account management, and audit logging. Using the identified embeddings, the data processing system can query the graph data structure to identify a subset of security framework control nodes applicable to container orchestration environments and a subset of object nodes corresponding to the production Kubernetes cluster and associated identity provider. The data processing system can generate a subgraph that includes the identified nodes and edges representing expected relationships between the security framework controls and the SaaS platform components.

The data processing system can analyze the subgraph to generate a remedial action for addressing a gap in an applicable security framework. For example, the data processing system can identify an expected-but-missing edge between a security framework control node representing periodic privilege review and the node representing Kubernetes service accounts used by the SaaS application. Based on the missing edge, the data processing system can generate a remedial action indicating that service account privileges are not periodically reviewed in accordance with the security frameworks. The data processing system can generate the remedial action by executing a graph neural network using the subgraph as input to produce candidate remedial actions and confidence scores, and can execute a large language model to generate a natural-language remediation description. In some implementations, the data processing system can automatically implement the remedial action by initiating a configuration change to enable automated service account audits, can update the graph data structure to reflect the new control relationship, and can store the updated subgraph for use in generating future remedial actions across the SaaS platform and across multiple security frameworks.

The above-described embodiments of the present disclosure are presented for purposes of illustration and not of limitation, and the present disclosure is limited by the claims which follow. Furthermore, it should be noted that the features and limitations described in any embodiment may be applied to one or more other embodiments herein, and flowcharts or examples relating to one embodiment may be combined with any other embodiment in a suitable manner, done in different orders, or done in parallel. In addition, the systems and methods described herein may be performed in real time or near real time. It should also be noted that the systems and/or methods described above may be applied to, or used in accordance with, other systems and/or methods. Furthermore, not every operation of a flowchart need to be performed.

Furthermore, the computing devices described in this disclosure may be any type of computing device unless otherwise stated, including, but not limited to, a laptop computer, a tablet computer, a hand-held computer, and/or other computing equipment (e.g., a server), including “smart,” wireless, wearable, and/or mobile devices. Furthermore, the embodiments described in this disclosure may include an individual device that performs at least some of the operations described in this disclosure. Alternatively, other embodiments may include multiple computing devices acting collectively to perform at least some of the operations described in this disclosure.

In some embodiments, the operations described in this disclosure may be implemented in a set of processing devices (e.g., a digital processor, an analog processor, a digital circuit designed to process information, an analog circuit designed to process information, a state machine, and/or other systems for electronically processing information). The processing devices may include one or more devices executing at least some of the operations of the methods in response to instructions stored electronically on one or more non-transitory, machine-readable media (e.g., a set of machine-readable storage media), such as an electronic storage medium. Furthermore, the use of the term “media” may include a single medium or combination of multiple media, such as a first medium and a second medium. One or more non-transitory machine-readable media storing instructions may include instructions included on a single medium or instructions distributed across multiple media. For example, non-transitory media may act as one or more memory, where one or more memory may store program instructions that are written as source files or written in machine-executable program code. The processing devices may include one or more devices configured through hardware, firmware, and/or software to be specifically designed for the execution of one or more of the operations of the methods.

In some embodiments, the various computer systems and subsystems illustrated in FIG. 3 or other figures described in this disclosure may include one or more computing devices that are programmed to perform the functions described herein. The computing devices may include one or more electronic storages (e.g., a set of databases accessible to one or more applications depicted in the system 300), one or more physical processors programmed with one or more computer program instructions, and/or other components. For example, the set of databases may include one or more relational databases. Alternatively, or additionally, the set of databases or other electronic storage used in this disclosure may include one or more non-relational databases.

The computing devices may include communication lines or ports to enable the exchange of information with a set of networks (e.g., a network used by the system 300) or other computing platforms via wired or wireless techniques. The network may include the internet, a mobile phone network, a mobile voice or data network (e.g., a 5G or Long-Term Evolution (LTE) network), a cable network, a public switched telephone network, or other types of communication networks or combination of communication networks. A network described by devices or systems described in this disclosure may include one or more communications paths, such as Ethernet, a satellite path, a fiber-optic path, a cable path, a path that supports internet communications (e.g., IPTV), free-space connections (e.g., for broadcast or other wireless signals), Wi-Fi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Each of these devices described in this disclosure may also include electronic storages. Electronic storage may include one or more non-transitory machine-readable media (e.g., storage media) that electronically store information. The storage media of the electronic storages may include one or both of (i) system storage that is provided integrally (e.g., substantially non-removable) with servers or client computing devices, or (ii) removable storage that is removably connectable to the servers or client computing devices via port (e.g., a USB port, a firewire port, etc.) or drive (e.g., a disk drive, etc.). The electronic storages may include one or more optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private network, and/or other virtual storage resources). An electronic storage may store software algorithms, information determined by the processors, information obtained from servers, information obtained from client computing devices, or other information that enables the functionality as described herein.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A system, comprising:
memory; and
one or more processors configured by machine-readable instructions stored in the memory to:
identify one or more electronic documents each corresponding to a different network security framework providing a structured approach for managing and reducing cybersecurity risk;
generate a vector database comprising embeddings converted from each of the one or more electronic documents;
generate a graph data structure comprising a first set of nodes corresponding to controls or requirements of the different network security frameworks, each of the first set of nodes storing an embedding from the vector database corresponding to a control or requirement represented by the node, the graph data structure further comprising a second set of nodes representing objects of a computing environment;
generate an embedding of an input requesting information about the different network security frameworks as related to the objects of the computing environment;
identify one or more embeddings of portions of electronic documents corresponding to network security frameworks applicable to the computing environment from the vector database based on the embedding of the input;
query the graph data structure using the one or more embeddings to identify a subset of the first set of nodes that correspond to controls or requirements of the network security frameworks applicable to the computing environment;
generate a subgraph from the identified subset of the first set of nodes that correspond to the controls or requirements of the security frameworks applicable to the computing environment and a subset of the second set of nodes linked by edges with the first set of nodes representing objects of the computing environment; and
generate, using the edges between the first and second sets of nodes of the subgraph, a remedial action for addressing a gap in a control or requirement of an applicable security framework with respect to one or more objects of the computing environment.

2. The system of claim 1, wherein the one or more processors are further configured to:
receive the input as a natural language query from a user interface presented on a client device; and
present an indication of the remedial action at the client device on the user interface.

3. The system of claim 1, wherein the one or more processors are further configured to:
automatically implement the remedial action within the computing environment to reduce cybersecurity risk within the computing environment.

4. The system of claim 3, wherein the one or more processors are further configured to automatically implement the remedial action by:
automatically initiating at least one configuration change, security control adjustment, or software update to a component of the computing environment.

5. The system of claim 1, wherein the one or more processors are configured to:
generate the remedial action for addressing the gap in the control or requirement of the applicable security framework with respect to one or more objects of the computing environment by generating an indication of an expected-but-missing edge between nodes of the subgraph, an indication of an expected-but-missing node within the subgraph, or an indication of an unexpected node or edge within the subgraph.

6. The system of claim 1, wherein the one or more processors are further configured to:
retrieve the portions of the electronic documents corresponding to the one or more embeddings based on the embedding of the input; and
generate the remedial action based further on the retrieved portions of the electronic documents.

7. The system of claim 1, wherein the one or more processors are configured to generate the remedial action by:
executing a graph neural network using the subgraph as input, the graph neural network trained based on one or more historical subgraphs containing nodes generated based on the different network security frameworks.

8. The system of claim 7, wherein the one or more processors are configured to generate the remedial action by:
executing a large language model using an output of the graph neural network generated based on the input to generate the remedial action.

9. The system of claim 8, wherein the one or more processors are configured to execute the large language model to generate the remedial action by:
iteratively repeating the query of the graph data structure, the generation of the subgraph, the execution of the large language model, and the execution of the graph neural network until determining the remedial action satisfies an acceptance criteria.

10. The system of claim 9, wherein the one or more processors are configured to execute the large language model to generate the remedial action by:
executing, as part of determining whether the remedial action satisfies the acceptance criteria, a validation large language model configured to evaluate completeness of the remedial action relative to the subgraph to determine whether the remedial action satisfies the acceptance criteria; and
responsive to the validation large language model determining that the remedial action is incomplete based on the determination as to whether the remedial action satisfies the acceptance criteria, automatically triggering at least one additional iteration of the query of the graph data structure and the generation of the subgraph to obtain additional controls, requirements, or objects omitted from a prior iteration.

11. The system of claim 1, wherein the one or more processors are configured to generate the remedial action by:
executing a graph neural network using the subgraph as input to generate a plurality of candidate remedial actions and confidence scores for the plurality of candidate remedial actions; and
executing a large language model using the plurality of candidate remedial actions and the confidence scores for the plurality of candidate remedial actions to select the remedial action.

12. A method comprising:
identifying, by one or more processors, one or more electronic documents each corresponding to a different network security framework providing a structured approach for managing and reducing cybersecurity risk;
generating, by the one or more processors, a vector database comprising embeddings converted from each of the one or more electronic documents;
generating, by the one or more processors, a graph data structure comprising a first set of nodes corresponding to controls or requirements of the different network security frameworks, each of the first set of nodes storing an embedding from the vector database corresponding to a control or requirement represented by the node, the graph data structure further comprising a second set of nodes representing objects of a computing environment;
generating, by the one or more processors, an embedding of an input requesting information about the different network security frameworks as related to the objects of the computing environment;
identifying, by the one or more processors, one or more embeddings of portions of electronic documents corresponding to network security frameworks applicable to the computing environment from the vector database based on the embedding of the input;
querying, by the one or more processors, the graph data structure using the one or more embeddings to identify a subset of the first set of nodes that correspond to controls or requirements of the network security frameworks applicable to the computing environment;
generating, by the one or more processors, a subgraph from the identified subset of the first set of nodes that correspond to the controls or requirements of the security frameworks applicable to the computing environment and a subset of the second set of nodes linked by edges with the first set of nodes representing objects of the computing environment; and
generating, by the one or more processors, using the edges between the first and second sets of nodes of the subgraph, a remedial action for addressing a gap in a control or requirement of an applicable security framework with respect to one or more objects of the computing environment.

13. The method of claim 12, further comprising:
receiving, by the one or more processors, the input as a natural language query from a user interface presented on a client device; and
presenting, by the one or more processors, an indication of the remedial action at the client device on the user interface.

14. The method of claim 12, further comprising:
automatically implementing, by the one or more processors, the remedial action within the computing environment to reduce cybersecurity risk within the computing environment.

15. The method of claim 12, wherein generating the remedial action further comprises:
executing, by the one or more processors, a graph neural network using the subgraph as input, the graph neural network trained based on one or more historical subgraphs containing nodes generated based on the different network security frameworks.

16. The method of claim 15, wherein generating the remedial action further comprises:
executing, by the one or more processors, a large language model using an output of the graph neural network generated based on the input to generate the remedial action.

17. One or more non-transitory, computer-readable media, comprising instructions that, when executed by one or more processors, cause one or more operations comprising:
identifying one or more electronic documents each corresponding to a different network security framework providing a structured approach for managing and reducing cybersecurity risk;
generating a vector database comprising embeddings converted from each of the one or more electronic documents;
generating a graph data structure comprising a first set of nodes corresponding to controls or requirements of the different network security frameworks, each of the first set of nodes storing an embedding from the vector database corresponding to a control or requirement represented by the node, the graph data structure further comprising a second set of nodes representing objects of a computing environment;
generating an embedding of an input requesting information about the different network security frameworks as related to the objects of the computing environment;
identifying one or more embeddings of portions of electronic documents corresponding to network security frameworks applicable to the computing environment from the vector database based on the embedding of the input;
querying the graph data structure using the one or more embeddings to identify a subset of the first set of nodes that correspond to controls or requirements of the network security frameworks applicable to the computing environment;
generating a subgraph from the identified subset of the first set of nodes that correspond to the controls or requirements of the security frameworks applicable to the computing environment and a subset of the second set of nodes linked by edges with the first set of nodes representing objects of the computing environment; and
generating, using the edges between the first and second sets of nodes of the subgraph, a remedial action for addressing a gap in a control or requirement of an applicable security framework with respect to one or more objects of the computing environment.

18. The computer-readable media of claim 17, wherein the instructions, that when executed by the one or more processors, further cause one or more operations comprising:
automatically implementing the remedial action within the computing environment to reduce cybersecurity risk within the computing environment.

19. The computer-readable media of claim 17, wherein the instructions, that when executed by the one or more processors, further cause one or more operations to generate the remedial action comprising:
executing a graph neural network using the subgraph as input, the graph neural network trained based on one or more historical subgraphs containing nodes generated based on the different network security frameworks.

20. The computer-readable media of claim 19, wherein the instructions, that when executed by the one or more processors, further cause one or more operations to generate the remedial action comprising:
executing a large language model using an output of the graph neural network generated based on the input to generate the remedial action.
